(19) United States
(12) Patent Application Publication
(10) Pub. No.: US 2008/0281822 A1
(43) Pub. Date: Nov. 13, 2008

(54) Interactive System For Building, Organising, and Sharing One's Own Databank of Works of Literature in one or More Languages

(76) Inventor: Gautam Dharamdas Goradia, Maharashtra (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/598,541

(22) PCT Filed: Feb. 18, 2005
(86) PCT No.: PCT/IN05/00052

§ 371 Date: Sep. 1, 2006

(30) Foreign Application Priority Data
Mar. 3, 2004 (IN) 252/MUM/2004

(51) Int. Cl. G06F 17/30

(52) U.S. Cl. 707/7; 707/E17.001

(57) ABSTRACT

An interactive system for building, organizing, and sharing one's own databank of works of literature in one or more languages is disclosed, it being accepted that one may want to build such data based on one's personal interest, by well-defined classifications, using a computer system comprising of; a. (i) a User Interface; (ii). a Database comprising a. a Literature Bank Database; b. a Translation Database; c. a User Database; d. a Configuration Database; (iii) At least one data input, organizing and management module(s) allowing a user to input, append, modify, and translate well-classified data (iv) Module allowing a user to invoke a Literature Session; (v) Module allowing the user to Export data from the Database(s); (vi) Module allowing the user to Import data built by another user using the same system.

### FIELD OF INVENTION

The present invention relates to an interactive system for building (including saving, appending, retrieving, modifying), organising, and sharing one's own databank of works of Literature such as novels, short stories, poems, essays, scripts, rhymes, theses, verse, composition, manuscripts, transcripts, articles and such others, in one or more languages, it being accepted that one may want to build (including saving, appending, retrieving, modifying) and organise such data based on one's personal interest of Literature in one or more languages, by well-defined classifications like Language, Source of Information, Type of Literature, Age Group, Genre and Sub Genre, Author/Poet; store additional information such as Synopsis, Background of Literature, Critical Appreciation, Book/Publication, Awards Won, Main Characters, and Remarks; use such data to, inter alia, improve one's own and others' knowledge by taking Literature Sessions, Attach Image, Animation and/or Sound files to the same, Associate more information in the form of Files, URLs, Remarks to the same, Translate the same into one or more languages of the user's choice; Print data, as well as obtain a plurality of Reports; share such data.

### BACKGROUND OF THE INVENTION

It is a well-accepted fact that Literature is an integral part of a person's education and daily life. Further it is known that Literature has served as one of the fundamental building blocks of any civilisation, and the level of progress and advancement of a civilisation is often measured by the level of advancement in its Literature.

It is also a well-accepted fact that any field or sphere of human activity has some Literature connected with it and that people come in contact with Literature, in one form or the other, either fictional or non-fictional, on a daily basis. It is also a well-accepted fact that a person who is well versed in Literature, either general or relating to a specific field, has an advantage in daily life over a person who is not so well versed. It is also a well-accepted fact that people often read Literature for the purpose of acquiring information and knowledge or simply for the purpose of enjoyment.

It is a well-accepted fact that works of Literature classified as “Fiction” are very popular in society and can be a powerful tool in altering perceptions and values. It is also a well-accepted fact that such works of Literature often have a direct bearing and influence on real-life situations and on the future of civilisation. It is also a well-accepted fact that such works of Literature also serve as a channel for providing humour, philosophy, guidance, understanding and ideas.

It is a well-accepted fact that people come in contact with works of Literature classified as “Non-fiction” on a daily basis, in the form of articles and short stories related to current affairs, business, science, entertainment, politics and other such fields; and that such articles and short stories are often used as sources of information or as sources of reference for use in people's daily social and professional lives. It is a well-accepted fact that many people often preserve articles appearing in newspapers, magazines, scientific journals and other publications, or over the Internet, for the purpose of future reference. It would be helpful for such people if they could be able to search and retrieve a particular article or short story or essay swiftly and efficiently, thus avoiding the tedious task of searching through reams of Literature.

It would be useful for readers of all types of Literature to be able to store and display such types of Literature in a well-classified manner for the enhancement of knowledge and education, as well as for the purpose of enjoyment.

It is also a well-accepted fact that many people write their own works of Literature in the form of poems, short stories articles, etc. for personal or professional interests, in a unique manner. It is also a well-accepted fact that such people often review and edit their work several times. It would be useful for such people to be able to store and display such works of Literature, as well as to share the same with others.

It is a well-accepted fact that there are many publishing houses and companies involved in publishing works of Literature from time to time.

It is also well known that where such data is available over the Internet, the classification of data is not comprehensive or necessarily user-friendly and may not always allow users to conveniently locate or find data for their use.

It is a well-known fact that Literature as a subject is an integral part of education, and as such requires a deep understanding of the material being studied, by methods such as critical appraisals, synopsis', author's notes, etc. It is also a well-known fact that such methods are important to students and teachers both, and help to gain a deeper understanding of the subject material. It is also a well-accepted fact that students and teachers are required to reach their own understanding of the subject material and form their own opinions of the same. It would be useful for people to be able to store and display such material, along with added critical reviews and notes, for the purpose of enhancing the learning material, as well gaining a deeper understanding of the same.

It is well known that people may sometimes want to read just an excerpt rather than reading an entire book. For example, in a book featuring works of different authors/poets, one may want to read the works of only a particular author/poet. It would therefore be very helpful for such people if there were to exist a System that would allow them to store works of Literature according to their personal preferences.

It is a well-accepted fact that people like to build their own anthologies of selected works of Literature. For this purpose, they take material from various sources and group it together. It would therefore be useful for such people, if there were to exist a System that would make it easier for people to build such anthologies in a well-classified manner.

It is a well-accepted fact that any work of Literature, when accompanied by illustrations or images, enhances the reading experience, since people tend to respond to such illustrations/images better than the text. Moreover, such illustrations/images serve as an effective teaching aid. It would therefore be useful if there were to exist a System that would allow people to store works of Literature along with suitable illustrations/images.

It is a well-accepted fact that works of Literature as such continue to educate and inspire people, and therefore there are several programs based on them that are being produced and broadcast through various media like television, radio, Internet among others. It is also a well-known fact that works of Literature are often the inspiration for films, television programs and the like.

It is a well-accepted fact that people generally cannot remember a large amount of data whether by classifications or not, without external help, and it would be very helpful if there were to exist a System that would help people to Add, Retrieve, Organise, Modify, Delete, Print, Export, and Import such data, thereby helping people to remember such data for use in daily life, to increase their knowledge on the same.

### JP2004030234 Information Management System

PROBLEM TO BE SOLVED: To provide an information management system in which information on literary works, etc. owned by an individual or a group can effectively be utilized.

SOLUTION: In the information management system 1 in which a management system 3 for managing the information owned by a registrant commissioned by the registrant is connected with unspecified many user-side terminal devices 5 through a communication network 12 to transmit and receive the information between these management system 3 and the user-side terminal devices 5, the management system 3 is provided with: a transmission and reception means 14 for transmitting and receiving a digital signal according to access from the user-side terminal devices 5; a database 11 for accumulating registered information which comes to be managed by commission by the registrant in the form of the digital signal; a disclosure requirement setting means 15 for setting disclosure requirements required for disclosing the registered information about each registered information; and a disclosure requirement determination means 16 which permits transmission of only registered information meeting the disclosure requirements.

### JP11296502 Method and Device for Analyzing Literature

PROBLEM TO BE SOLVED: To provide a completely new analyzing method and analyzing device for literature which can objectively analyze the sentence style structure of very subjective literature by using computing equipment such as a computer and a spatial theory method which is a mathematical method as a well-worn device and was not seen before. SOLUTION: This is a method for analyzing literature, and three kinds of linear independent element data that the literature has, are subjected to an orthogonal component extracting process (S1) using Gram-Schmidt relation, a normalizing process (S2), and a multi-resolution analyzing process (S3) using wavelet conversion; and three-dimensional data including the obtained three kinds of normalized orthogonal system linear independent element data as (x)-, (y)-, and (z)-directional components are obtained at each resolution level (S4) and represented in a four-dimensional space.

### JP9160923 Literature Data Base File Management System

PROBLEM TO BE SOLVED: To easily manage literature data base file going more enormous by executing operation such as registration, change and deletion for the literature data base file by the use of a data base operation part. SOLUTION: An input part 1 inputs an author's name or a subject specifying a literature and a retrieval part 2 retrieves whether literature data corresponding to input data are included in the literature data base file or not. When literature data corresponding to the input data exist as the retrieved result, the literature data are displayed on the screen of a display. When a user instructs to register the literature data, a literature database operation part 3 registers the literature data in the literature data base file. When there is no literature data corresponding to the input data, whether the user has instructed for the change of literature data or not, is checked, and when the change is instructed, the literature data in the file are changed.

U.S. Pat. No. 4,712,174 Method and Apparatus for Generating Text

A computer based system for generating text from a predetermined database, in either prose or poetic form, in response to a plurality of input data provided by an operator in an interactive mode of operation with the computer. The preferred embodiment disclosed produces limerick style poetry in response to name, gender, geographic place of residence, primary and secondary traits and the number of syllables in certain input data items, and includes poetic material related to each of these data input items.

U.S. Pat. No. 6,370,498 Apparatus and Methods for Multi-Lingual User Access

An apparatus and method for the multi-lingual creation and retrieval of a work from a database storing multiple texts and/or translations of works in a variety of formats. A user can create and retrieve multiple translations of a work and may choose to have the multiple texts and/or translations presented in different formats. For example, the user may choose to have a document displayed textually in two separate languages, or in text in one language and in audio in a second language.

The prior art systems described in the foregoing descriptions have an inherent limitation, in that, they do not allow the user to build, organise, sufficiently enjoy, and share their own databank of works of Literature in one or more languages. Therefore, by dint of determined research and intuitive knowledge, our inventor has developed an interactive System that enables users to build (including saving, appending, retrieving, modifying), organise, and share their own databank of works of Literature by well-defined Classifications, translate the same into one or more languages, and which further enables users to improve their and others' knowledge by means of Literature Sessions, and which further enables users to export data to other users of this System, and which further allows users to import data built by other users of this System.

### SUMMARY OF THE INVENTION

An object of the present invention is to allow the user to build, organise, and share one's own databank of works of Literature in one or more languages, it being accepted that one may want to build (including saving, appending, retrieving, modifying) and organise such data in one or more languages, based on one's personal interest and further store it by well-defined classifications like Date, Language, Source of Information, Age Group, Type of Literature, Genre and Sub Genre, Author/Poet, and Publisher, such classification of data not restricted to any already provided data.

Yet another object of the present invention is to allow the user to store additional information about a work of Literature such as Synopsis, Background of Literature, Critical Appreciation, Book/Publication, Awards Won, Main Characters, and Remarks.

Yet another object of the present invention is to maintain a history of the records viewed by the user in such a databank of works of Literature.

Yet another object of the present invention is to allow users to FIND data rapidly and efficiently by none or one or more FIND conditions, wherein the FIND conditions to find the Records from the Database(s) are defined by none or one or more Criteria like the Date, Record ID, Language, Source of Information, Age Group, Type of Literature, Genre and Sub Genre, Title, Author/Poet, Main Characters, Awards won, Book/Publication, and Publisher, as well as by keywords, wildcard characters, by whether or not a Record has File Attachments/Associations and/or Attachment/Association Remarks, whether or not the Record has been imported and further by Import Remarks, and/or whether or not a Record has been Bookmarked and further by Bookmark Remarks, and/or whether or not a Record is marked as “Private” or “Public”, and/or “Favourite”, as well as assigned a Rating, and/or by whether or not a Record has been used in a Literature Session and if so, the number of times it has been used. The user can exercise the option of using the above conditions to bring forth or avoid Records by the specified conditions.

Yet another object of the present invention is to allow the user to add Bookmark Remarks, Attachments, Associations of Files, including Media files, URLs and more Remarks and further Attachment/Association Remarks to the Records.

Yet another object of the present invention is to allow users to mark Records as “Public” or “Private”, individually or globally, and assign the same to specific users or user groups.

Yet another object of the present invention is to allow users to assign a Rating to the Records, individually or globally, and assign the same to specific users or user groups.

Yet another object of the present invention is to allow users to mark selected Records as “Favourite”, and assign the same to specific users or user groups.

Yet another object of the present invention is to allow users to Navigate efficiently between the Records.

Yet another object of the present invention is to allow users to Modify data individually and globally, and further selectively.

Yet another object of the present invention is to allow users to share data created by the users using the Export/Import/Print utilities, such Exporting/Importing/Printing of data capable of being done selectively.

Yet another object of the present invention is to allow users to delete the data, individually or globally, sending the deleted data to the Recycle Bin of the System, and further restoring or deleting the same, singularly or plurally.

Yet another object of the present invention is to allow users to take Literature Session(s) using the works of Literature stored in the Database(s), by finding the same by none or one or more FIND conditions.

Yet another object of the present invention is to provide various Reports selectively and having the further utility of customising the same.

Yet another object of the present invention is to provide the necessary Tools to the user for better customisation and maintenance of the System in various ways.

Yet another object of the present invention is to allow one or more module(s)/utility(s) to operate within a browser and/or other viewing and/or processing programs.

Yet another object of the present invention is to provide a utility for creating, editing, deleting, printing, navigating, finding Masters like Language, Source of Information, Type of Literature, Age Group, Genre and Sub Genre, Author/Poet, Publisher, with sufficient security so as not to allow the deletion of any Master of a Record that may be in use.

Yet another object of the present invention is to provide users with a Translation utility, allowing the user to consider any Record as a parent language Record and Translate the same into one or more languages of the user's choice, the translation activity happening from a Translation Module which is invoked in the Literature Bank Module, and further that all of the features and/or utility(s)/functionality(s) available in case of the parent language Record are available in case of its translation.

Yet another object of the present invention is to allow the user to Print any Record of the user's choice as well as obtain a plurality of Reports.

Yet another object of the present invention is to allow the user to input and/or modify data in the Database(s) by Voice input, with or without a conjunction of input made by keyboard support, and/or to use any other utility(s)/functionality(s) of the System, as may be supported by the System for such use, by Voice Command, and further to allow the user to receive Voice Output of the data so entered/modified by the user.

These and other embodiments of the present invention are further made apparent, in the remainder of the present document, to those of ordinary skill in the art.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which the following are represented in an illustrative and non-restrictive way. These drawings are not to be considered limitations in the scope of the invention, but are merely illustrative.

FIG. 1 is the diagram of the System block according to an embodiment of the present invention.

FIG. 2 is the diagram of the Multiple User System according to an embodiment of the present invention

FIG. 3 is the diagram of the Outline of the System Process according to an embodiment of the present invention

FIG. 4 is the diagram of the System Function of the Literature Bank Module according to an embodiment of the present invention

FIG. 5 is the diagram of the System Operation of the Literature Bank Module according to an embodiment of the present invention

FIG. 6 is the diagram of the System State Transition of the Literature Bank Module according to an embodiment of the present invention.

FIG. 7 is the diagram of the System Function of the Global Changes Module according to an embodiment of the present invention.

FIG. 8 is the diagram of the System Operation of the Global Changes Module according to an embodiment of the present invention.

FIG. 9 is the diagram of the System State Transition of the Global Changes Module according to an embodiment of the present invention.

FIG. 10 is the diagram of the System Function of the Literature Session Module according to an embodiment of the present invention.

FIG. 11 is the diagram of the System Operation of the Literature Session Module according to an embodiment of the present invention.

FIG. 12 is the diagram of the System State Transition of the Literature Session Module according to an embodiment of the present invention.

FIG. 13 is the diagram of the System Function of the Reports Module according to an embodiment of the present invention.

FIG. 14 is the diagram of the System Operation of the Reports Module according to an embodiment of the present invention.

FIG. 15 is the diagram of the System State Transition of the Reports Module according to an embodiment of the present invention.

FIG. 16 is the diagram of the System Function of the Export Module according to an embodiment of the present invention.

FIG. 17 is the diagram of the System Operation of the Export Module according to an embodiment of the present invention.

FIG. 18 is the diagram of the System State Transition of the Export Module according to an embodiment of the present invention.

FIG. 19 is the diagram of the System Function of the Import Module according to an embodiment of the present invention.

FIG. 20 is the diagram of the System Operation of the Import Module according to an embodiment of the present invention.

FIG. 21 is the diagram of the System State Transition of the Import Module according to an embodiment of the present invention.

FIG. 22 is the diagram of the System Function of the Recycle Bin Module according to an embodiment of the present invention.

FIG. 23 is the diagram of the System Operation of the Recycle Bin Module according to an embodiment of the present invention.

FIG. 24 is the diagram of the System State Transition of the Recycle Bin Module according to an embodiment of the present invention.

FIG. 25 is the diagram of the System Function of the Tools/Help Menu Options Module according to an embodiment of the present invention.

FIG. 26 is the diagram of the System Operation of the Tools/Help Menu Options Module according to an embodiment of the present invention.

FIG. 27 is the diagram of the System State Transition of the Tools/Help Menu Options Module according to an embodiment of the present invention.

FIG. 28 is the diagram of the System Function of the Translation Module according to an embodiment of the present invention.

FIG. 29 is the diagram of the System Operation of the Translation Module according to an embodiment of the present invention.

FIG. 30 is the diagram of the System State Transition of the Translation Module according to an embodiment of the present invention.

FIG. 31 is the diagram of the System Function of the Master Module according to an embodiment of the present invention.

FIG. 32 is the diagram of the System Operation of the Master Module according to an embodiment of the present invention.

FIG. 33 is the diagram of the System State Transition of the Master Module according to an embodiment of the present invention.

### DETAILED DESCRIPTION OF SPECIFIC EMBODIMENTS

A detailed description of the preferred embodiments and best modes for practicing the present invention are described herein. The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

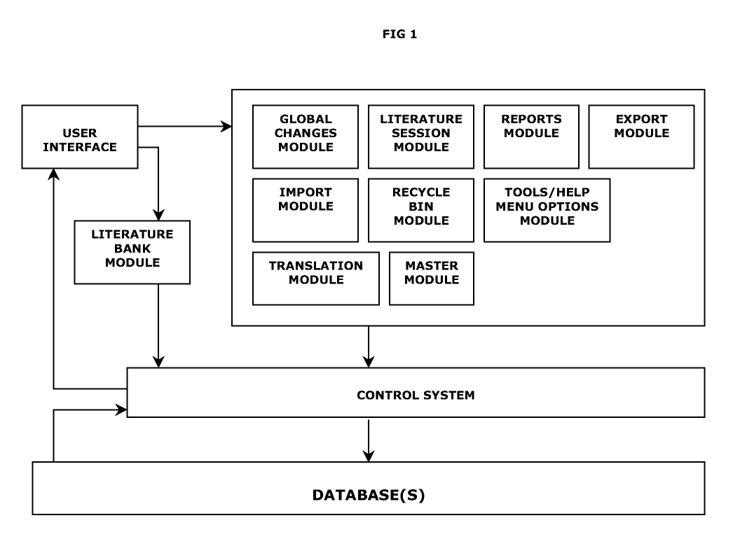

An interactive System for building (including saving, appending, retrieving, modifying) organising, and sharing one's own databank of works of Literature in one or more languages, wherein FIG. 1 is the diagram of the different functional blocks and their interaction of the present invention. The User Interface(s) render the user's actions, and with the help of the Control System transmits the appropriate requests to the Database(s). The Control System acts as the bridge between the User Interface(s) and the Database(s).

The Database(s) consists of Literature Bank Database, Translation Database, User Database and the Configuration Database. Literature Bank Database is the reservoir of an extensible collection of well-classified data and further stores the data user wise. The Translation Database is the reservoir of the translated data. The User Database is the reservoir of the user information and also contains the history of past user interaction with the System. The Configuration Database is the reservoir of the options used for the Customization of the System.

If the user requests for the Literature Bank Module through the User Interface, then the Control System asks the Database Management System to find the corresponding data from the Database(s), resulting in the display of the relevant data, if available. The user then interacts further with the Literature Bank Module through the User Interface with respect to the utilities available in this Module.

If the user requests for the Global Changes Module through the User Interface, then the Control System asks the Database Management System to find the corresponding data from the Database(s), resulting in the display of the data, if available. The user then interacts further with the Global Changes Module through the User Interface with respect to the utilities available in this Module.

If the user requests for the Literature Session Module through the User Interface then the Control System asks the Database Management System to find the corresponding data from the Database(s), resulting in the display of the data, if available. The user then interacts further with the Literature Session Module through the User Interface with respect to the utilities available in this Module.

If the user requests for the Reports Module through the User Interface, then the Control System asks the Database Management System to find the corresponding data from the Database(s), resulting in the display of the relevant data, if available. The user then interacts further with the Reports Module through the User Interface with respect to the utilities available in this Module.

If the user requests for the Export Module through the User Interface, then the Control System asks the Database Management System to find the corresponding data from the Database(s), resulting in the display of the relevant data, if available. The user then interacts further with the Export Module through the User Interface with respect to the utilities available in this Module.

If the user requests for the Import Module through the User Interface, then the Control System asks the Database Management System to retrieve the corresponding data from a valid database file resulting in the display of the relevant data, if available. The user then interacts further with the Import Module through the User Interface with respect to the utilities available in this Module.

If the user requests for the Recycle Bin Module through the User Interface, then the Control System asks the Database Management System to find the corresponding data from the Database(s) resulting in the display of the relevant data, if available. The user then interacts further with the Recycle Bin Module through the User Interface with respect to the utilities available in this Module.

If the user requests for the Tools/Help Menu Options Module through the User Interface, then the Control System asks the Database Management System to retrieve the corresponding Options available from the Database(s). The user then interacts further with the Tools/Help Menu Options Module through the User Interface with respect to the utilities available in this Module.

If the user requests for the Translation Module through the User Interface, then the Control System asks the Database Management System to find the corresponding data from the Database(s), resulting in the display of the relevant data, if available. The user then interacts further with the Translation Module through the User Interface with respect to the utilities available in this Module.

If the user requests for the Master Module through the User Interface, then the Control System asks the Database Management System to find the corresponding data from the Database(s) resulting in the display of the relevant data, if available. The user then interacts further with the Master Module through the User Interface with respect to the utilities available in this Module.

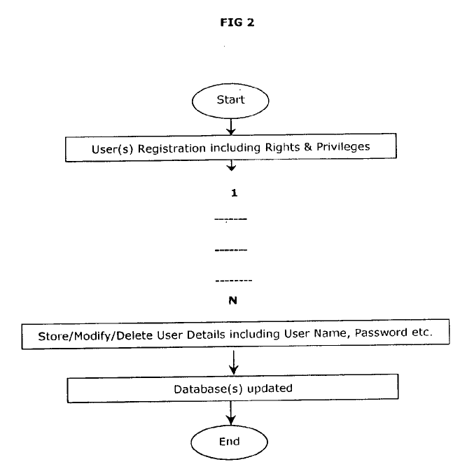

FIG. 2 is the diagram of the Multiple User System of the present invention. It explains that multiple users can use the System at the same time, and also explains that the System can be controlled by rights and privileges. It further allows the user to Store/Modify/Delete the User Details including User Name, Password etc. in the Database(s). Whenever a user wishes to log in to the System, the user has to provide a User Name and password. The user can further modify an existing password. Further, there is also a utility which allows the creation of new users.

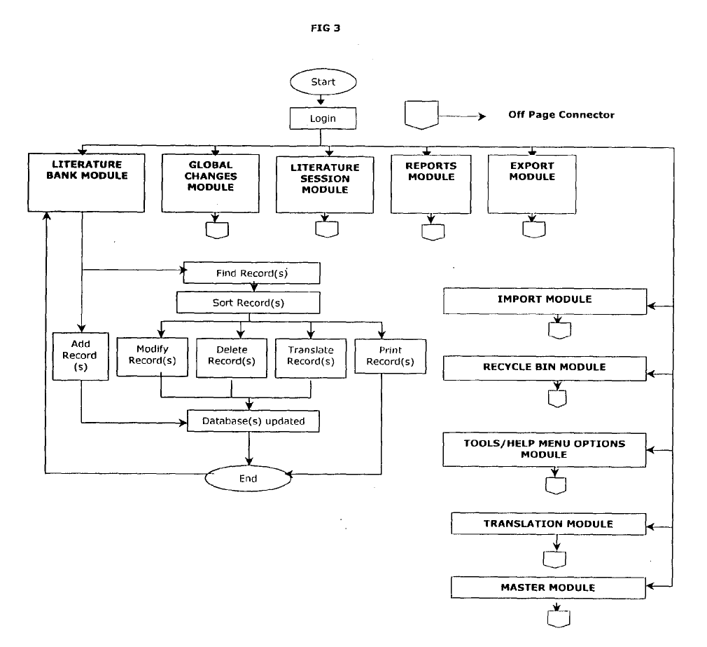

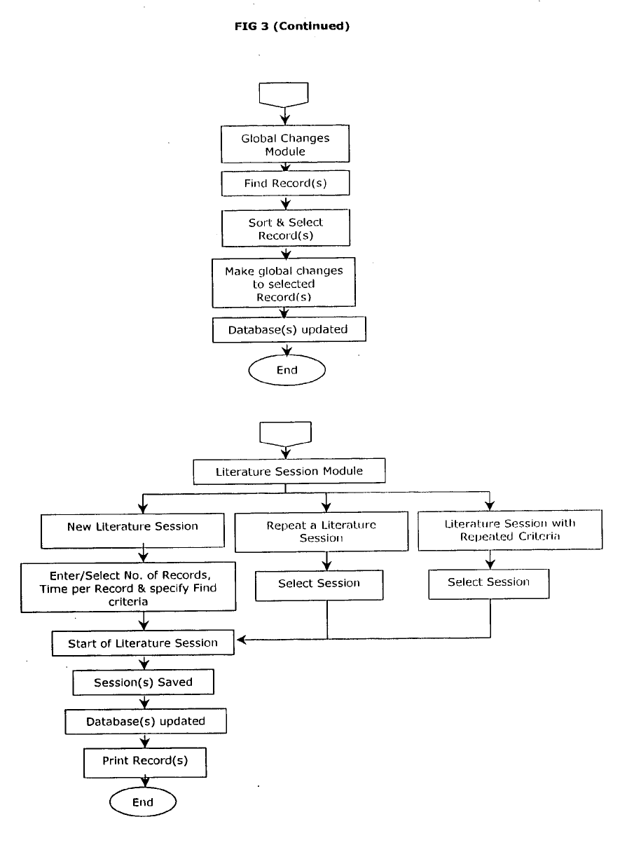

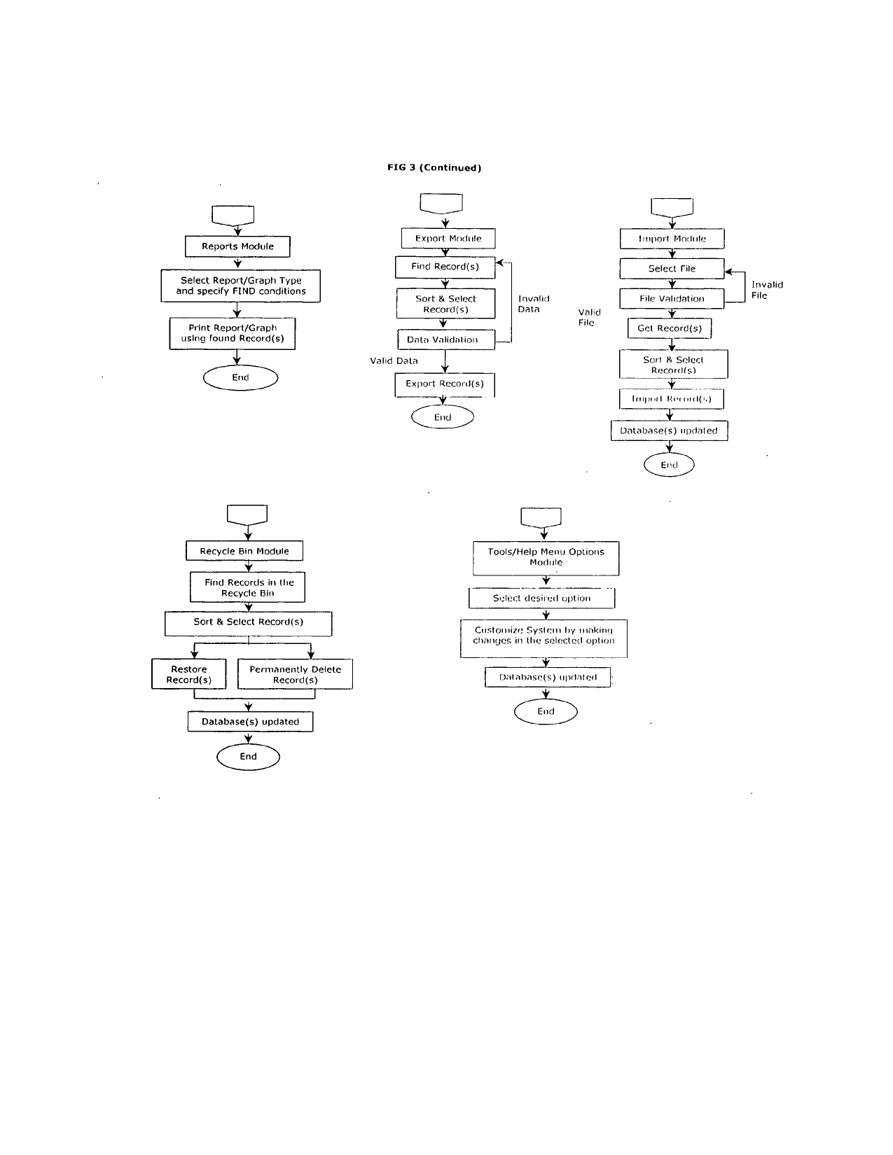

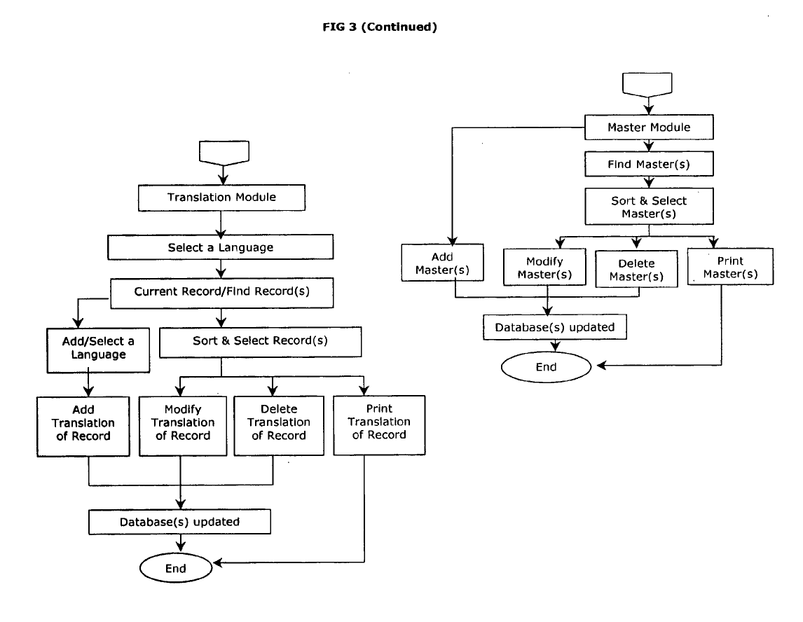

FIG. 3 is the diagram of the outline of the System Process of the present invention. It exhibits the Modules of the System and their main functions.

FIGS. 4 to 9 explain the System Function, System Operation, and System State Transition respectively of the Literature Bank Module and Global Changes Module respectively of the present invention. The Literature Bank Module allows the user to create, store, and organise works of Literature such as novels, short stories, poems, essays, scripts, rhymes, theses, verse, composition, manuscripts, transcripts, articles and such others by well-defined classifications. The Global Changes Module allows the user to globally Modify part(s) of Records, globally Delete Records, globally Bookmark Records, globally mark Records as “Public” or “Private”, as well as “Favourite”, globally assign a Rating, globally Associate additional information in the form of File(s)/URL(s)/Remark(s) to Records, globally Attach a File such as an Image, Animation, or a Sound file to Records, or globally Translate Records.

FIG. 4 is the diagram of the System Function of the Literature Bank Module of the present invention. The architecture of this Module comprises the following functions, which allow a user to create, store, and organise works of Literature by well-defined classifications with the help of the User Interface.

The Literature Bank Module through the User Interface causes the Control System to find and retrieve the relevant data from the Database(s). The Module allows a user to:
Enter/Select a Language
Create, store, and organise works of Literature by well-defined classifications
Copy Current Entry
Find the available hierarchy(s) of Genre and Sub Genre
Find related Record(s) having the same Classifications as that of the current Record, as may be defined by the user
Attach/Associate File(s)/URL(s)/Remark(s) to Record(s)
Find existing Record(s) from the Database(s) by none or one or more FIND conditions
Sort and Select Records
Modify Record(s)
Add/Modify Record(s) by Voice Input as well as receive Voice Output of Record(s)
Translate Record(s)
Delete Record(s)
Go to a Record and Navigate between Records
Print Record(s) by various Print conditions
Bookmark Record(s)
Mark Record(s) as “Public” or “Private”
Mark Record(s) as “Favourite”
Assign a Rating to Record(s)
Send Record(s) as SMS/MMS and or via Email and/or Network Messaging
Export Record(s)

FIG. 5 describes the System Operation of the Literature Bank Module explaining that the Module is based on user actions. The Literature Bank Module accepts data in one or more languages (such data capable of being accepted from more than one user at the same time), with or without voice, by well-defined classifications like (1) Date (the same being generated automatically by the System and/or which can be modified by the user if needed), (2) Language (the user selects from the available languages or adds a new one) (3) Source of Information (to record the Source from where the user obtained the details the user is entering—EXAMPLE—The user may have read an article, or a short story, or an essay in a particular book or magazine or dictionary or website—say “XYZ” and would like to store this as Source of Information), (4) Type of Literature (to record the type of the work of Literature—EXAMPLE—if the user is writing or storing a short story, then the Type of Literature in this case would be ‘SHORT STORY’) (5) Age group (to record the relevant Age Group for which the work of Literature is meant for—EXAMPLE—the nursery rhyme ‘JACK AND JILL’ could be classified under the Age Group JUNIORS while the three-part poem ‘The Waste Land’ by T. S. Eliot could be classified under the Age Group SENIORS), (6) Genre (to record the genre to which the work of Literature belongs—EXAMPLE—A work of Literature based on imaginary characters and situations may be classified under the Genre ‘FICTION’), (7) Sub Genre (to record the sub genre to which the work of Literature belongs—EXAMPLE—If a particular work of Literature is classified under the Genre ‘FICTION’, then its Sub Genre could be ‘SCIENCE FICTION’). (8) Author/Poet (to record the name of the Author /Poet of the work of Literature or of the Book/Publication wherein the work of Literature has featured) (9) Publisher (to record the name of the Publisher of the work of Literature or of the Book/Publication wherein the work of Literature has featured).

When the user enters this Module, the Control System brings forth a User Interface from where the user can enter/select a Language, create and store works of Literature by well-defined classifications, find the available hierarchy(s) of Genre and Sub Genre, find related Record(s) having the same Classifications as that of the current Record, as may be defined by the user, Attach/Associate File(s)/URL(s)/Remark(s) to Record(s), Find existing Record(s) from the Database(s) by none or one or more FIND conditions, Modify Record(s), Add/Modify Record(s) by Voice Input as well as receive Voice Output of Record(s), Translate Record(s), Delete Record(s), View the current Find result, Go to a Record and Navigate between Records, Print Record(s) by various Print conditions, Bookmark Record(s), Mark Record(s) as “Public” or “Private” as well as “Favourite”, assign a Rating, Use the ‘Zoom’ option, Send Record(s) as SMS/MMS and or via Email and/or Network Messaging, view Import Status, and Export Record(s). The user can also choose not to use any of these functionalities and close the User Interface to come out of the Module. All of these functionalities are described below in detail.

If the user chooses to create and store works of Literature, the user must first enter/select a Language. When the user chooses to create a work of Literature, the Control System brings forth a User Interface which prompts the user to copy the current work of Literature if any, facing the user, in terms of data input fields comprising of the Header (Classifications), data input field for the work of Literature itself, Remarks, Book/Publication, Publisher, and/or Attachment/Association(s), such “Copy Current Entry” utility being of immense use to the user to simplify the creation of works of Literature having at least common Classifications. If a user selects to copy the Header (Classifications), then the Classifications under which the current work of Literature facing the user is classified, will be copied. —EXAMPLE—if a user has an existing work of Literature classified as:

### SOURCE OF INFORMATION: “O'HENRY AWARDS 1999”

### TYPE OF LITERATURE: SHORT STORY

### AGE GROUP: SENIORS

### GENRE: FICTION

### SUB GENRE: MODERN FICTION

### TITLE: A NURSE'S STORY

### AUTHOR/POET: PETER BAIDA

### PUBLISHER: UNIVERSITY PRESS OF MISSISSIPPI

And the new work of Literature being created by the user also happens to be falling under the above Classifications, the “Copy Current Entry” utility would make the new entry easier for the user, in that, the user would not have to reclassify the new entry. If a user selects to copy the work of Literature itself and Remarks, the current work of Literature and Remarks, facing the user will be copied. If a user selects to copy entries made in data input fields, facing the user, such as Book/Publication, Publisher etc, then such entries will be copied accordingly. If a user selects to copy the Attachment/Associations to the current Record facing the user, then the Attachment/Associations will be copied accordingly. If a user chooses not to use this “Copy Current Entry” utility, then the Control System gets notified and blanks out all the relevant data input fields for new data input by the user.

The user can then check whether the user is duplicating an entry by choosing to find the available hierarchy of Genre and Sub Genre by which the Record(s) are stored in the Database(s), as well as Record(s) having the same Classifications as that of the current Record facing the user. The hierarchy of Genre and Sub Genre is found according to what the user has entered as Genre and/or Sub Genre—EXAMPLE—If the user has not entered or selected any Genre and Sub Genre, the Control System brings forth all the available hierarchy(s) of Genre and Sub Genre by which the work(s) of Literature are classified and stored in the Database(s). If the user has entered or selected the Genre as “FICTION”, the Control System brings forth the hierarchies of Genre and Sub Genre pertaining to the Genre “FICTION”. Further if the user has entered or selected “FICTION” in either the Genre or Sub Genre, the Control System brings forth hierarchy(s) of Genre and Sub Genre where “FICTION” is there in either the Genre or Sub Genre. The user can select any hierarchy from the Find Results and can enter this hierarchy in the data input fields provided for Genre and Sub Genre in the User Interface.

If the user chooses to find Record(s) having the same classifications as that of the current Record facing the user, the Control System brings forth a User Interface showing a grid which displays the Find Results accordingly.

The user can create and/or store a work of Literature by entering accordingly in the relevant data input fields provided for the purpose. It is mandatory for the user to do this, else the work of Literature will not be saved as a Record in the Database(s). The user can enter or select relevant classifications for the work of Literature as mentioned above. The user can enter and/or store a work of Literature such as a novel, short story, poem, essay, script, rhyme, thesis, verse, composition, manuscript, transcript, article and such others in a data input field provided for the purpose. The user also has the option of adding images and other types of graphics in this data input field. This data input field provides the user with various editing and formatting options for text and graphics. The user also has a ‘Zoom’ option whereby the contents of this data input field are shown as zoomed in a separate User Interface. The user can also add, view, and modify the contents in the data input field through this ‘zoomed’ User Interface. The user can also use the ‘Zoom’ option while navigating between Records. The user can further enter additional information about the work of Literature, such as Title of the work of Literature, Synopsis, Book/Publication wherein the particular work of Literature might have featured, the Publisher of the work of Literature, the Background of the work of Literature, a Critical appreciation of the work of Literature, and additional Remarks if any, in data input fields provided for the purpose.

The user can further choose to Attach/Associate additional information like File(s) including Image, Animation or Sound File(s), URL(s), and Remark(s) to the work of Literature being created by the user—EXAMPLE—The user may want to Attach a File such as an Image, Animation, or a Sound file, or the user may want to Associate more information by means of associating some information that may be on a File or a Web Site, and hence the user would Associate a File or URL. The user can open and view such File(s), provided the relevant applications for opening the File(s) are installed on the user's computer system. Further, in case of a File Attachment the user can open and view the same in a separate User Interface. In case of a URL, the same would be opened by the Control System provided the user is connected to the Internet. The user may also simply wish to Associate a REMARK to the work of Literature. Such REMARKS are displayed to the user on demand. In case the user wants to Attach/Associate File(s), the Control System brings forth a User Interface from where the user must browse for and select the File(s), from a computer system. In case the user wants to Associate URL(s) or Remark(s), the user must enter the same into a data input field provided for the purpose. The user can further enter Remarks about each Attachment/Association in data input fields provided for the purpose. The user can further delete the Association(s) or remove the Attachment that the user might have given at this time. The Control System updates the Database(s) in this case. The user also has the further option of viewing the Attached File using the ‘Zoom’ option whereby the contents of the File are shown as zoomed in a separate User Interface.

After the user creates a work of Literature in the manner described above and chooses to save it, the Control System saves the same accordingly, generates a new Record Id for the same, and updates the Database(s). The Control System generates a new Record ID each time a new entry is made by a user or when a Record is imported by the user.

If the user wants to find existing work(s) of Literature stored in the Database(s), the Control System brings forth a User Interface from where the user enters/selects a FIND criterion, and based on the same, the Control System finds and retrieves the Record(s) from the Database(s). The user can find work(s) of Literature by none or one or more FIND conditions. The user can find work(s) of Literature stored in the Database(s) by a Date and Record Id range. —EXAMPLE—If the user wants to find work(s) of Literature created between particular dates, the user has to select the appropriate dates in the From Date and To Date fields in the User Interface. If the user wants to find Record(s) by their Record ID, then the user has to enter the Record Id of the desired Record(s) in the From Record Id field and To Record Id fields of the User Interface. If the user wishes to find work(s) of Literature created in the German Language, the user has to enter or select GERMAN in the Language field in the User Interface. If the user wishes to find work(s) of Literature pertaining to the Source of Information ‘XYZ’, the user must enter or select ‘XYZ’ in the Source of Information field in the User Interface. If the user wishes to find work(s) of Literature which have a title ‘ABC’, the user must enter or select ‘ABC’ in the Title field of the User Interface. If the user wishes to find work(s) of Literature classified under the Age Group ‘HIGH SCHOOL’, the user must enter or select the Age Group ‘HIGH SCHOOL’ in the Age Group field in the User Interface. If the user wishes to find all work(s) of Literature that are poems, then the user must enter or select POEM in the Type of Literature field in the User Interface. If the user wishes to find work(s) of Literature classified under the Genre ‘FICTION’, then the user must enter or select ‘FICTION’ in the Genre field in the User Interface. The user can further find work(s) of Literature classified under the Sub Genre ‘SCIENCE FICTION’ by entering or selecting ‘SCIENCE FICTION’ in the Sub Genre field in the User Interface. Further, if the user wishes to find all work(s) of Literature that have been classified under the Genre ‘FICTION’ and the Sub Genre ‘SCIENCE FICTION’, then the user must enter or select ‘FICTION’ and ‘SCIENCE FICTION’ in the Genre and Sub Genre fields respectively of the User Interface. If the user wishes to find all work(s) of Literature by a particular author or poet, then the user must enter or select the name of that author or poet in the Author/Poet field in the User Interface. If the user wishes to find all work(s) of Literature wherein certain literary characters have been mentioned, then the user must enter the name(s) of those literary characters in the Main Characters field in the User Interface. If the user wishes to find all work(s) of Literature that have won certain awards, then the user must enter the names of those awards in the Awards Won field in the User Interface. If the user wishes to find all work(s) of Literature that have featured in a particular book or publication, then the user must enter the name of that book or publication in the Book/Publication field in the User Interface. If the user wishes to find all work(s) of Literature that have been published by a particular publisher, then the user must enter or select the name of that publisher in the Publisher field in the User Interface. The user can also enter relevant keywords in the keywords field of the User Interface, which would bring forth those Record(s), which contain the exact match or part thereof of the keywords entered by the user. The user can enter more than one keyword and can also choose to include or exclude the whole or part of any keyword—EXAMPLE—The user can enter one or more keywords separated by a space in the keywords field, and further the user can add a “+” separator or a “−” separator to include or exclude the subsequent word with respect to the immediately preceding word. The user can further enter the keyword within quotation marks to find Record(s) containing the exact match for the keyword. The Control System searches for the keyword in all the fields of the Records and brings forth the Find Results accordingly. The user can further find Record(s) by whether or not the Record(s) have been Bookmarked. In case where the Record is Bookmarked, the user can find it by entering the appropriate Bookmark Remarks that the user may have assigned to the Record at the time of bookmarking the Record in the Module. The user has the further option of excluding the entered Bookmark Remark. —EXAMPLE—If the user has entered the Bookmark Remarks as “XYZ” and chooses to exclude the same, then the Control System will avoid showing those Record(s) where “XYZ” is there in the Bookmark Remarks, in the Find Results. The user can further find Record(s) by specifying a Rating which the user may have assigned to the Record(s) in the Module—EXAMPLE—If the user wants to find Record(s) which have been assigned a Rating ‘*****’, then the user must select ‘*****’ in the Rating field of the User Interface. The user can further find Record(s) by a Criteria of whether or not the Record(s) have Associations and/or File Attachments. If the user selects to find Record(s) that have File Attachments, the user must further select the type of the File Attachment as either an Image, Animation, or a Sound file. The user has a further option to exclude the type of the File Attachment. —EXAMPLE—If the user selects the type of the File Attachment as ‘IMAGE’ and chooses to exclude the same, the Control System will bring forth Find Results showing those Record(s) which do not have Image files as Attachments. Further the user can find Record(s) by entering the relevant Attachment and/or Association Remarks if any, related to the Attachment and/or Association of the Record(s). The user has a further option to exclude the entered Attachment and/or Association Remark(s). —EXAMPLE—If the user has entered the Attachment and/or Association Remarks as “XYZ” and chooses to exclude the same, then the Control System will bring forth Find Results showing those Record(s) where “XYZ” is not there in the Attachment and/or Association Remarks. The user can further find by the Import Remarks, if any, given to the Records that were imported, with a further option to find by excluding the same in the same manner as described in case of Attachment/Association Remarks. The user can also choose to find by more than one master for a particular Criteria by using the Custom option. —EXAMPLE—the user can choose to find Record(s) for the Age Groups ‘JUNIORS’ as well as ‘SENIORS’ at a time. The user can further find Record(s) by their Frequency of Occurrence—EXAMPLE—In case of Frequency of Occurrence, the user finds by whether or not a Record has appeared in a Literature Session and if so, the number of times it has appeared, and also the time period in which it has appeared. The user has a further option to find Record(s) by excluding the Frequency of Occurrence as may be specified by the user.

If the user chooses none of the FIND Criteria described above, then the Control System brings forth Find Results showing all the Record(s) stored in the Database(s), by all the FIND Criteria. If the user chooses one of the FIND Criteria described above, then the Control System brings forth Find Results showing Record(s) pertaining only to that Criteria. If the user chooses more than one FIND Criteria described above, then the Control System brings forth Find Results showing Record(s) pertaining to the Criteria chosen by the user. The System further provides the user with a utility whereby the user can specify the Control System to remember the FIND Criteria the next time when the user either chooses to find Record(s) or when the user logs into the System. This utility is part of the Grid Option described in FIG. 26.

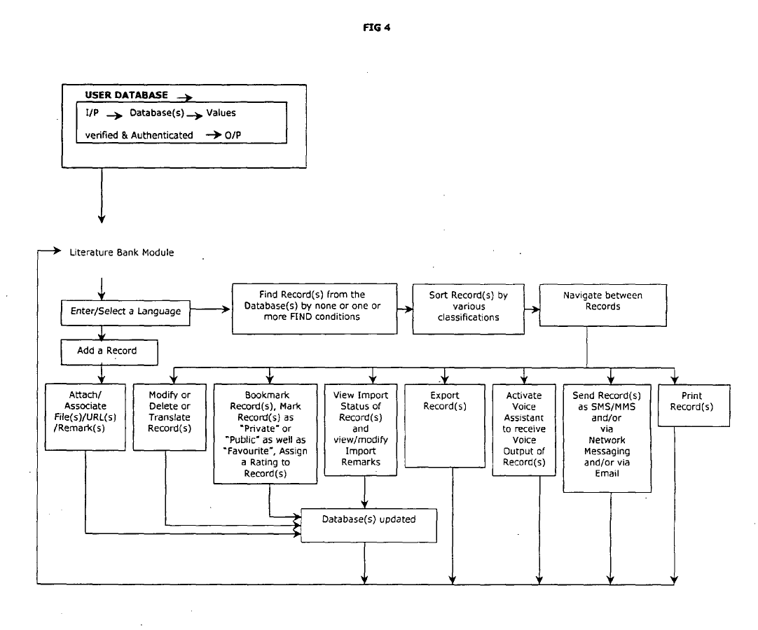

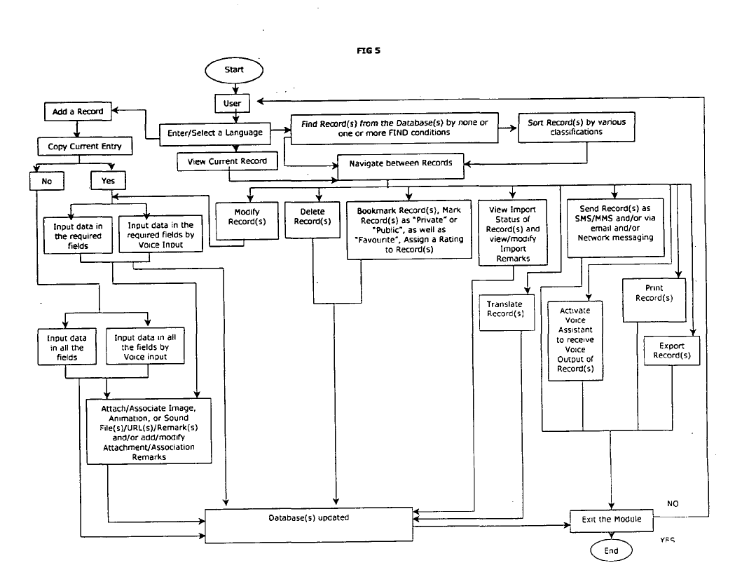

After the user has chosen to find the Record(s) by none or one or more of the FIND conditions described above, the Control System brings forth a User Interface showing a grid displaying the Record(s) brought forth according to the FIND conditions, and from where the user can Sort and Select the Record(s) in the grid. The grid shows the Records in terms of their fields like Record Id, Title, Author(s)/Poet(s), Type of Literature, Age Group, Language, Genre, Book/Publication, Publisher, Bookmark, Favourite, and Rating which are displayed as columns. The user can Sort the Records, in ascending or descending order, by Classifications. The user can apply the Sort condition to the Records currently displayed in the Find Result grid facing the user or the entire set of found Records. The user can Sort the Records, in ascending or descending order, by clicking on any column in the grid. —EXAMPLE—If the user clicks on the Genre column, then all the Records in the grid will get sorted by genre of the Records in ascending or descending order. Further, the user can select the Record(s) in the grid and further view all the selected Record(s) through a “Selected So Far” utility. The Control System brings forth a User Interface wherein the user can further Sort and select Record(s) as well as undo this selection. The user can also view the Classification details of the Record(s). The user can further print the selected Record(s). The user can further make global changes to the selected Record(s), as described in FIGS. 7 and 8.

The following utilities are available to a user from the User Interface displaying the Find Result grid:
1. Sort and Select the Records by various Classifications as explained above
2. Select single or multiple Records as well as undo selections of the same as explained above
3. View details of selected Records as explained above
4. View selected Records in another grid through a ‘Selected so far’ utility, with a further possibility to undo the selections on the Records from this grid.
5. View existing Bookmark Remarks of the Records as well as add, modify, or remove Bookmark Remarks
6. Print the selected Records
7. Make global changes as mentioned above
8. Take a Literature Session using the selected Records as explained below
9. Export the selected records as explained below

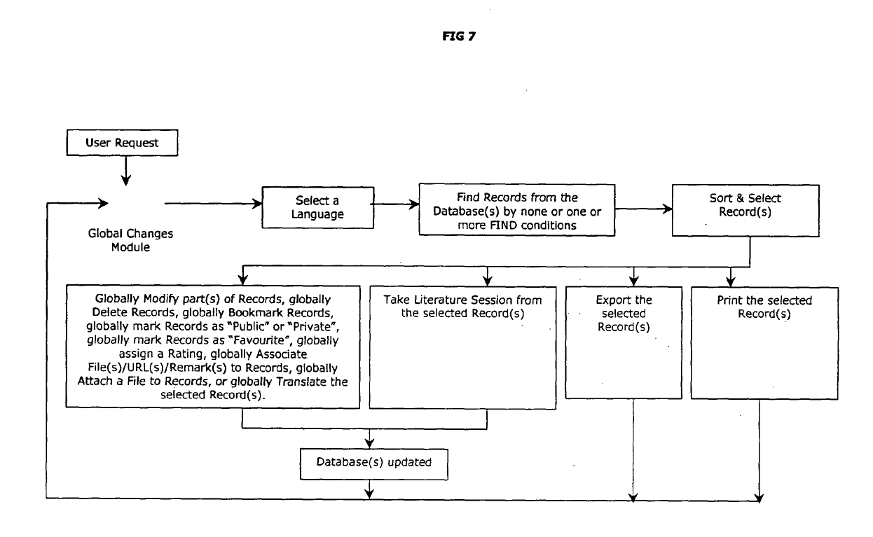

If the user chooses to take a Literature Session from the selected Record(s), then the Control System brings forth a User Interface from where the user can enter/select Criteria like the Literature Session Title, time of display per Record, select to activate Background Music during the Literature Session, and start the Literature Session. The Control System then starts a Literature Session which is described in detail in FIGS. 10 and 11. At the end of a Literature Session, the Control System saves the Literature Session, generates a new Literature Session Id for the same, and thus updates the Database(s). After the user has taken a Literature Session in this manner, the Control System then takes the user back to the User Interface displaying the Find Result grid.

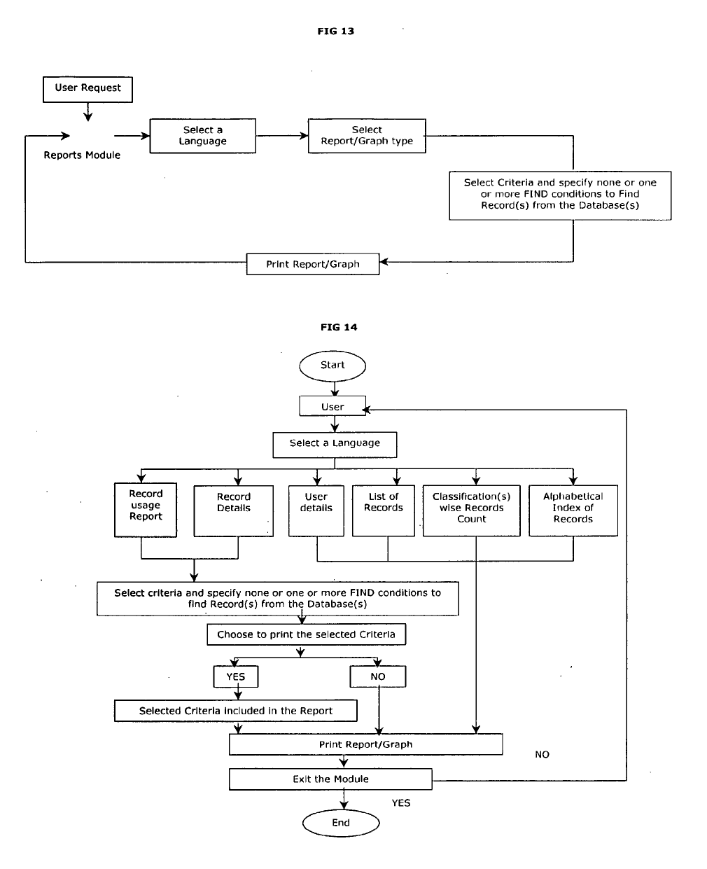

If the user chooses to Export the selected Record(s) the Control System brings forth a User Interface from where the user must browse for and select the desired file/folder destination on a computer system where the user wants to export. The Control System creates a Database file using the selected Record(s) at the file/folder destination on a computer system as specified by the user and notifies the user that the Record(s) were successfully exported and also displays the number of Record(s) exported. The utility(s)/functionality(s) available to the user at the time of exporting Record(s), as described in FIGS. 16 and 17, are also available in this case. After the user exports the selected Record(s), the Control System then takes the user back to the User Interface displaying the Find Result grid.

Double clicking on any Record in the Find Result grid will take the user to the concerned Record in the Module. The Find result brought forth for a particular criteria are saved until the user finds Record(s) by new criteria, or closes the User Interface displaying the Literature Bank Module. The user has the option of viewing the latest Find result for a particular Find criteria through a User Interface in the Literature Bank Module.

If the user wishes to Modify an existing Record in this Module, all the utility(s)/functionality(s) available at the time of creating the work(s) of Literature would be available to the user and using the same, the user can make further modifications in the same if required. After modification, if the user chooses to save, the Control System saves the modifications and updates the Database(s).

If the user wishes to Delete an existing Record in this Module, the Control System prompts the user as to whether or not the user wishes to do so. If the user chooses to continue, the Control System deletes the Record from the Module, sends it to the Recycle Bin of the System, and updates the Database(s).

If the user chooses to Add and/or Modify Record(s) by Voice Input, the user can do so with or without a conjunction of input made by keyboard support, and/or use any other utility(s)/functionality(s) of the System, as may be supported by the System for such use, by Voice Command. The user can use all the utility(s)/functionality(s) available at the time of creating work(s) of Literature, by Voice Input. If the user creates a work of Literature by Voice Input and chooses to save, the Control System saves the same, generates a new Record Id, and updates the Database(s). The user can further choose to receive Voice Output of the Records by activating the Voice Assistant. A character appears which speaks out the text of the work of Literature through an embedded text to speech engine. The Control System saves the Voice Output of a particular Record in an mp3 file format, as may be specified by the user in the Voice Output option described in FIG. 26.

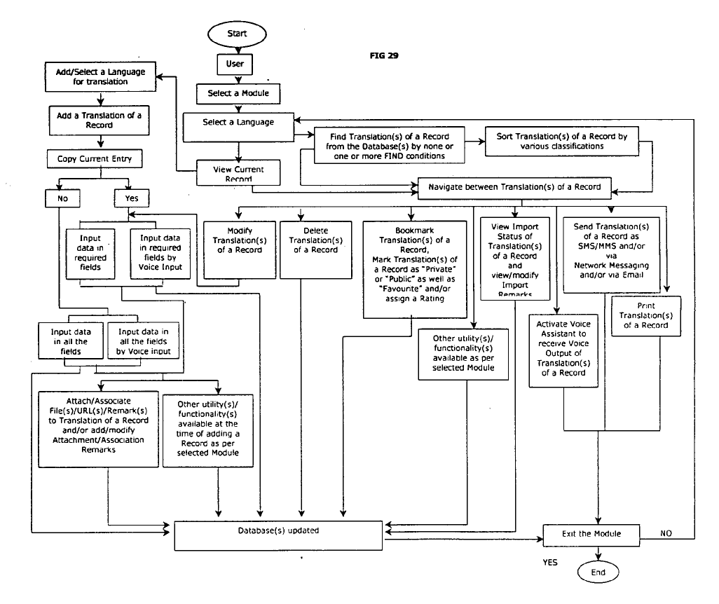

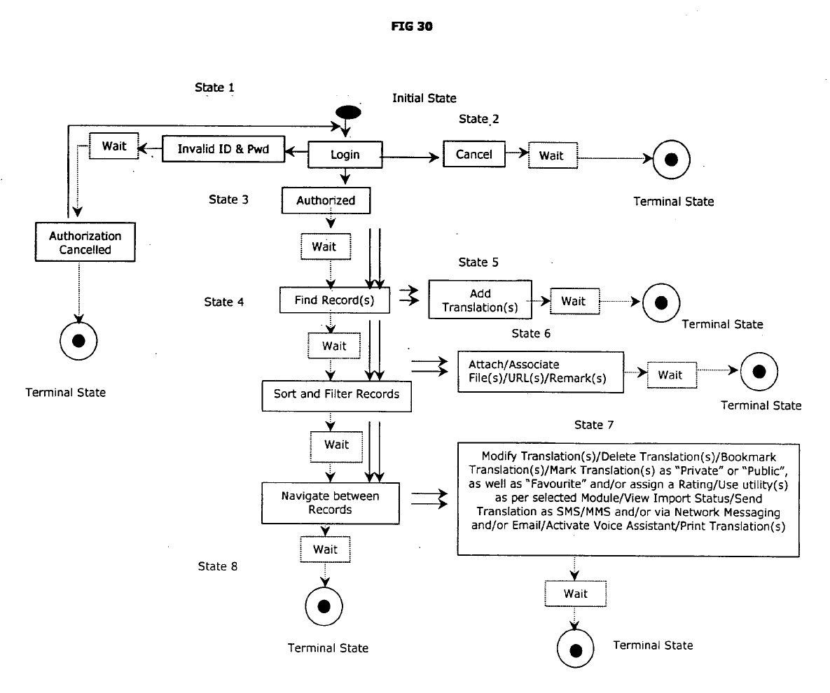

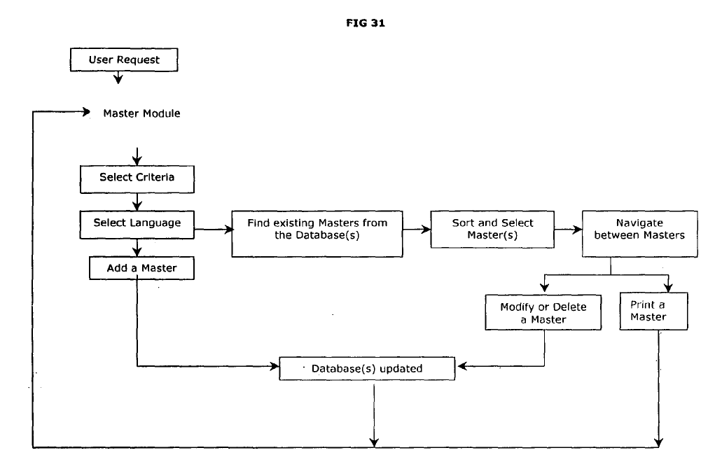

If the user chooses to Translate a Record in this Module, the user can do so by considering the Record as a parent Language Record and translate the same in any language of the user's choice. The translation is carried out in the manner described in the Translation Module in FIGS. 28 and 29. The Control System saves the Translation of the parent Language Record as a new Record, generates a new Record Id, and thus updates the Database(s).

The user can further navigate back and forth between the Records of this Module and can also choose to directly go to a Record by entering its Record Id or Title in data input fields in a User Interface provided for the purpose. The user has the further option of going to the last viewed Record. —EXAMPLE—When a user enters the Module, the current Record displayed to the user is the latest Record that has been added to the Database(s). If the user now goes to any other Record say having Record Id as 30 and wishes to return to the Record last viewed i.e. the latest Record in this case, then the user can use the ‘Back’ option to do so. If the user thus goes to the Record last viewed by using this option, the user can also return to the Record having Record Id as 30 by using the ‘Forward’ option. The Control System maintains a history of the Record(s) viewed by the user till the user exits the Module. By using the ‘Back’ and ‘Forward’ options, the user can navigate between such Record(s).

If the user chooses to Bookmark a Record in this Module, then the Control System brings forth a User Interface from where the user must enter some Bookmark Remarks in order to Bookmark the Record. The user can also view the earlier Bookmark Remarks, if any, and can further modify the same. The Control System bookmarks the Record accordingly. From the User Interface, the user can also remove the flag of Bookmark from the Record. The Control System updates the Database(s) whenever a Record is Bookmarked or the Bookmark flag is removed from it.

If the user chooses to mark a Record in this Module as “Public” or “Private” and/or “Favourite”, the Control System flags the Record accordingly. Further when a Record is marked as “Private” by a user who has logged in to the System, the Record will not be visible to other users who log into the same System at any other point of time. The user can also choose to remove the flag of “Public” or “Private” and/or “Favourite”. The Control System updates the Database(s) whenever a Record is marked as “Public” or “Private” and/or “Favourite”, or whenever these flags are removed from the Record.

If the user chooses to assign a Rating to a Record in this Module, then the Control System brings forth a User Interface from where the user must select the appropriate Rating in order to assign it to the Record. The Ratings in this case would be in the form of “*”, “**”, “***”, “****”, and “*****”. The Ratings can be assigned according to the Record. —EXAMPLE—If a work of Literature is well written, then it could be assigned a Rating of “*****” i.e. a high Rating. The Control System updates the Database(s) whenever a Record is assigned a Rating or the existing Rating assigned to a Record, if any, is modified.

If the user chooses to print Record(s) in this Module, the Control System brings forth a print preview of the same, from which the user can print further. The user can further choose to print Record(s) found by a FIND condition as specified by the user, in the same manner as that of the current Record. The Printing utility further allows the Print reports to be Exported to various destinations in various file formats.

A further utility allows the user to send the Record as SMS/MMS and/or via Email and/or Network Messaging.

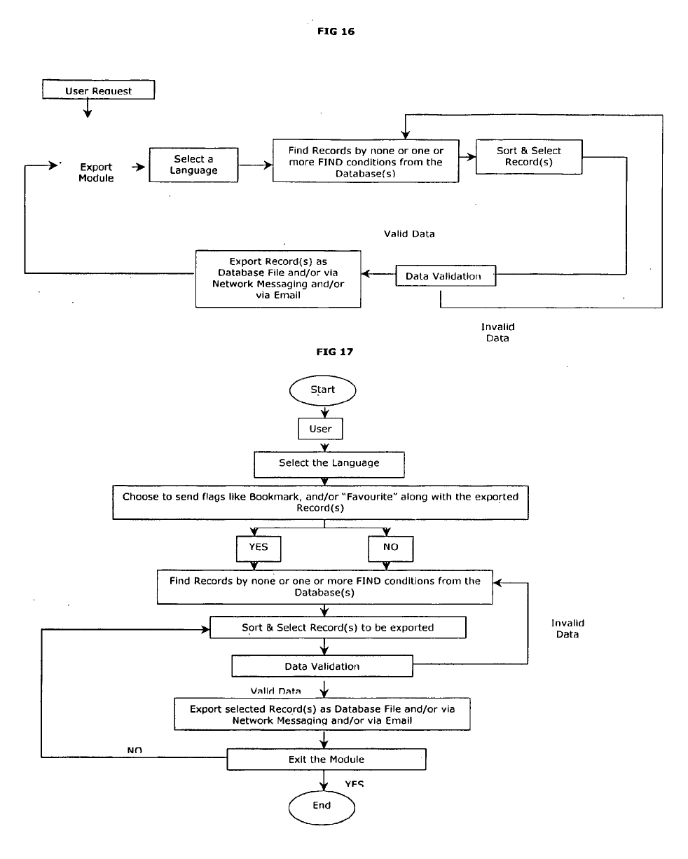

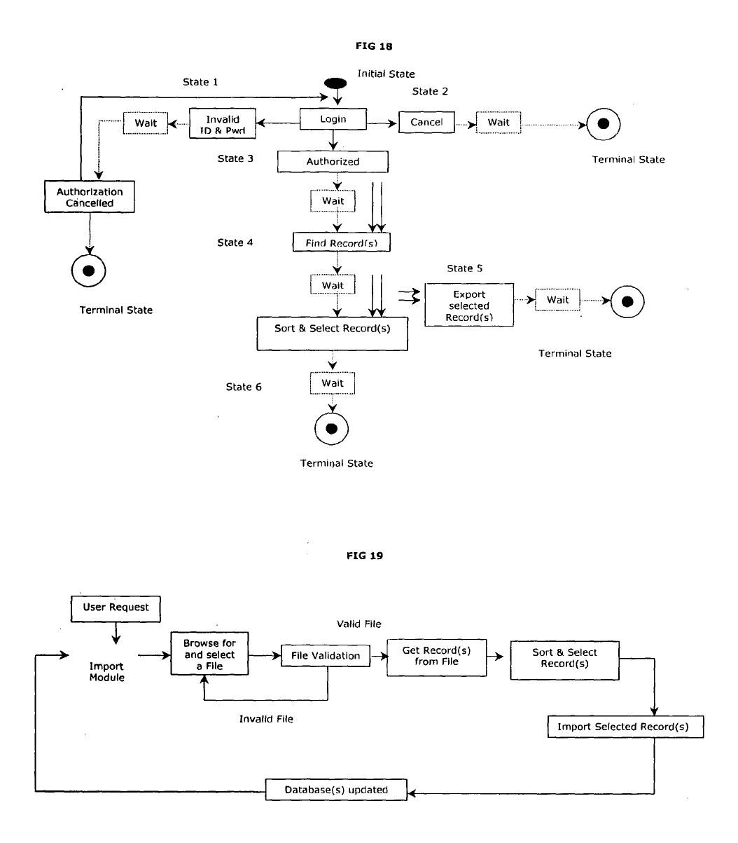

If the user chooses to view Import Status of a Record in this Module, the Control System will bring forth a User Interface showing whether or not the Record has been imported from a Database File in the manner described in the Import Module in FIGS. 19 and 20. The user can further view and modify the Import Remarks associated with the Record in a data input field provided for the purpose. The user can further choose to remove the Import Remarks. The Control System updates the Database(s) whenever the Import Remarks are added, modified, or removed. If the user chooses to Export an existing Record in this Module, the Control System brings forth a User Interface from where the user must browse for and select the desired file/folder destination on a computer system where the user wants to export. The Control System creates a Database file using the Record at the file/folder destination on a computer system as specified by the user and notifies the user that the Record was successfully exported and also displays the number of Record exported. The utility(s)/functionality(s) available to the user at the time of exporting Record(s), as described in FIGS. 16 and 17, are also available in this case.

The Module also accepts data built by another user (Exporting user) of the System, and which may be further manipulated by the user (Importing user) to suit the user's requirements. (EXAMPLE—the Exporting user may have classified a short story based on fictional events or characters under the genre FICTION, but the Importing user would like to classify the same under the genre FANTASY)

Any data entered or imported into the Literature Bank Module is further used as part of the functions of the other Modules of the System.

FIG. 6 describes the System State Transition of the Literature Bank Module explaining that the Module is based on different States. The System receives events from the user(s), and each event causes the transition from one state to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIG. 7 is the diagram of the System Function of Global Changes Module of the present invention. The architecture of this Module comprises the following major functions, which allow a user to make global changes to the Records stored in the Database(s) like globally Modifying part(s) of Records, globally Deleting Records, globally Bookmarking Records, globally marking Records as “Public” or “Private”, globally marking Records as “Favourite”, globally assigning a Rating, globally Associating additional information in the form of File(s)/URL(s)/Remark(s) to Records, globally Attaching a File such as an Image, Animation, or a Sound file to Records, or globally Translating Records with the help of the User Interface.

The Module allows a user to:
Select a Language
Find existing Records from the Database(s) by none or one or more FIND conditions
Sort and Select Record(s)
Globally Modify part(s) of Record(s), globally Delete Record(s), globally Bookmark Record(s), globally mark Record(s) as “Public” or “Private”, globally mark Record(s) as “Favourite”, globally assign a Rating to Record(s), globally Associate additional information in the form of File(s)/URL(s)/Remark(s) to Record(s), globally Attach a File such as an Image, Animation, or a Sound file to Record(s), or globally Translate the selected Record(s).

FIG. 8 describes the System Operation of the Global Changes Module, explaining that the Module is based on user actions.

When the user enters this Module, the Control System brings forth a User Interface from where the user must first select the Language in which the Records are to be brought forth and then find Record(s) from the Database(s) by none or one or more FIND conditions for making global changes. The FIND conditions in this case are the same as the ones described in FIG. 5. The Control System brings forth a User Interface, displaying the Find Results in a grid, and from where the user can Sort and Select the Record(s) for making global changes. The User Interface provides the user with the same utility(s)/functionality(s) applicable to Record(s) in a Find Result grid as described in FIG. 5. Double clicking on any Record in the grid will take the user to the Record in the Module. The user can choose to either globally Modify, globally Delete, globally Bookmark, globally mark as “Public” or “Private”, globally mark as “Favourite”, globally assign a Rating, globally Associate additional information in the form of File(s)/URL(s)/Remark(s), globally Attach a File such as an Image, Animation, or a Sound file, or globally Translate the selected Record(s).

If the user chooses to globally Modify selected Record(s), the Control System brings forth a User Interface from where the user can select the desired part or data input field of the Record(s) that the user wishes to Modify, enter/select to find that which is to be replaced in that selected data input field, and further enter/select to Replace that which is thus found, in specific data input fields provided for the purpose. —EXAMPLE—If the user selects a data input field like Age Group, for the selected Record(s), the user can select to find the Age Group say ‘JUNIORS’ and can enter or select to Replace it with the Age Group ‘SENIORS’. The Control System searches the Age Group field of the selected Record(s) for ‘JUNIORS’ and replaces it with ‘SENIORS’. Further, if the user selects a data input field like Remarks, then the user must enter some text which the user wishes to find to be replaced in the Remarks field and then enter the text that will replace this found text. —EXAMPLE—If the user enters ‘ABC’ to be found to be replaced and then enters ‘XYZ’ as the text to Replace ‘ABC’, the Control System will search the Remarks field of the selected Record(s) for all occurrences of ‘ABC’ and Replace it with ‘XYZ’. After entering or selecting to find and Replace, the Control System prompts the user as to whether or not the user wants to do the same. If the user continues, the Control System modifies the selected Record(s) accordingly, notifies the user that the selected Record(s) have been modified, and displays the number of Record(s) modified. The Control System updates the Database(s) whenever the Record(s) are modified.

If the user chooses to globally Delete the selected Record(s), the Control System prompts the user as to whether or not the user wishes to Delete the selected Record(s). If the user continues, the Control System deletes the selected Record(s) from the grid, notifies the user that the Record(s) have been deleted, and also displays the number of Record(s) deleted. The Control System sends the deleted Record(s) to the Recycle Bin of the System and updates the Database(s) accordingly.

If the user chooses to globally Bookmark the selected Record(s), the Control System brings forth a User Interface where the user must enter some Bookmark Remarks in order to Bookmark the selected Record(s). After the user enters the Bookmark Remarks and saves the same, the Control System prompts the user as to whether the user wishes to overwrite or append the existing Bookmark Remarks, if any, of the selected Record(s) in case such Record(s) have been bookmarked earlier. After the user selects either to overwrite or append the existing Bookmark Remarks, the Control System bookmarks the Record(s) accordingly, notifies the user that the Record(s) have been bookmarked, and displays the number of Record(s) bookmarked. The user can view the existing Bookmark Remarks of all Record(s) in the Find Result grid, in case such Record(s) have been bookmarked earlier. The user can further remove the Bookmark flag of the selected Record(s) in case such Record(s) have been bookmarked earlier. The Control System updates the Database(s) whenever the Record(s) are bookmarked or whenever the Bookmark flag is removed from the Record(s) which have been bookmarked earlier.

If the user chooses to globally mark the selected Record(s) as “Public” or “Private”, the Control System brings forth a User Interface where the user must select either to mark the Record(s) as “Public” or “Private”. After the user selects either one of these two options, the Control System prompts the user as to whether or not the user wishes to thus mark the selected Record(s). If the user continues, then the Control System marks the selected Record(s) as “Public” or “Private” as may be specified by the user, notifies the user that the Record(s) have been thus marked, and displays the number of Record(s) thus marked. The user can also remove the “Public” and “Private” flags of the selected Record(s) in case such Record(s) have been marked earlier as “Public” or “Private”. The Control System updates the Database(s) whenever the Record(s) are marked as “Public” or “Private” or whenever the flags of “Public” or “Private” are removed from Record(s) which have been marked earlier as “Public” or “Private”.

If the user chooses to globally mark the selected Record(s) as “Favourite”, the Control System prompts the user as to whether or not the user wishes to thus mark the selected Record(s). If the user continues, then the Control System marks the selected Record(s) as “Favourite”, notifies the user that the Record(s) have been thus marked, and displays the number of Record(s) thus marked. The user can also remove the “Favourite” flag of the selected Record(s) in case such Record(s) have been marked earlier as “Favourite”. The Control System updates the Database(s) whenever the Record(s) are marked as “Favourite” or whenever the flag of “Favourite” is removed from Record(s) which have been marked earlier as “Favourite”.

If the user chooses to globally assign a Rating to the selected Record(s), the Control System prompts the user as to whether or not the user wants to do the same. If the user continues, the Control System brings forth a User Interface from where the user can select the appropriate Rating that the user wishes to assign to the selected Record(s) in the same manner as described in FIG. 5. After the user has selected the appropriate Rating and continues, the Control System assigns the Rating to the selected Record(s), notifies the user that the Record(s) have been assigned a Rating, and displays the number of Record(s) which have been assigned a Rating. The user can also modify or remove the Rating(s) assigned to the selected Record(s), in case such Record(s) have been assigned a Rating earlier. The Control System updates the Database(s) whenever the Record(s) are assigned a Rating or whenever the existing Rating assigned to the selected Record(s) is modified or removed.

If the user chooses to globally Associate File(s)/URL(s)/Remark(s) to the selected Record(s), the Control System prompts the user as to whether or not the user wants to do the same. If the user continues, the Control System brings forth a User Interface from where the user can Associate File(s)/URL(s)/Remark(s), and also add Remarks about such associations. In case the user wants to Associate File(s) with the Record(s), the user can browse for and select the File(s), from a computer system. In case the user wants to Associate URL(s) or Remark(s), the user must enter the same into a data input field provided for the purpose. The user can further enter Remarks about each Association in a data input field provided for the purpose. From the User Interface, the user can also open and view the Associated File or URL and further can delete the Association(s) that the user might have given to the selected Record(s) at this time. If the user chooses to save the Association(s), then the Control System Associates the File(s)/URL(s)/Remark(s) to the selected Record(s), notifies the user about the same, and displays the number of Record(s) to which either File(s)/URL(s)/Remark(s) have been associated. The user can also delete all Association(s) of the selected Record(s) in case such Record(s) have been associated with File(s)/URL(s)/Remark(s) earlier. The Control System updates the Database(s) whenever File(s)/URL(s)/Remark(s) are associated and/or Association Remarks are added to the selected Record(s) or whenever any previous Associations are deleted from the selected Record(s).

If the user chooses to globally Attach a File to the selected Record(s), the Control System prompts the user as to whether or not the user wants to do the same, also notifying the user that the Attachment made by the user at this time will replace the earlier Attachment, if any, of the selected Record(s). If the user continues, the Control System brings forth a User Interface from where the user can Attach a File, and add Remarks about this Attachment. In order to Attach a File with the Record(s), the user must browse for and select the File, from a computer system. The user can further enter Remarks about the Attachment in a data input field provided for the purpose. From the User Interface, the user can also open and view the Attached File. If the user chooses to save the Attachment, then the Control System prompts the user to choose whether to Attach the File to all of the selected Record(s) or only to those selected Record(s) which do not have any File Attachment. Depending on the user's choice, the Control System Attaches the File to the selected Record(s) accordingly, notifies the user about the same, and displays the number of Record(s) to which the File has been attached. The user can also delete the Attachment(s) of the selected Record(s) in case such Record(s) have been attached with a File earlier. The Control System updates the Database(s) whenever a File is attached and/or Attachment Remarks are added, to the selected Record(s) or whenever any previous Attachment is deleted from the selected Record(s).

If the user chooses to globally Translate the selected Record(s), the Control System brings forth a User Interface from where the user must select the part(s) of the selected Record(s) to be translated and then enter/select the Language to do the same. The user must further enter the translation(s) of the selected part(s) in the Language entered or selected, in data input fields provided for the purpose. After entering the translation, the Control System prompts the user as to whether or not the user wants to save the same. If the user continues, the Control System translates the selected Record(s) accordingly, notifies the user that the selected Record(s) have been translated, and displays the number of Record(s) translated. The Control System updates the Database(s) whenever the Record(s) are globally translated.

When the user closes the User Interface from where the user can make global changes as described above, the Control System gets notified and the user comes out from the Module.

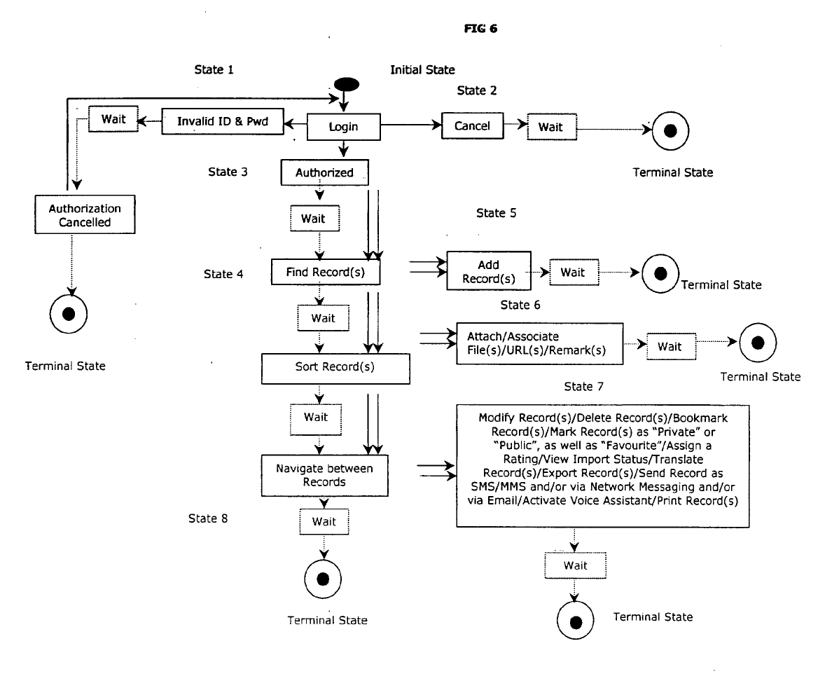

FIG. 9 describes the System State Transition of the Global Changes Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 10 to 12 explain the System Function, System Operation and System State Transition respectively of the Literature Session Module, which allows the user to invoke and store a Literature Session (such Literature Sessions capable of being taken by more than one user at the same time), using the data stored in the Database(s).

FIG. 10 is the diagram of the System Function of Literature Session Module of the present invention. The architecture of this Module comprises of the following major functions, which allow a user to invoke a Literature Session using the data stored in the Database(s), with the help of the User Interface.

The Module allows a user to:
Select a Language
Enter/Select Criteria like Literature Session Title, No. of Records to appear in the Literature Session, and time of display per Record
Activate Background Music
Take a Literature Session by using the Record(s) found from the Database(s) by none or one or more FIND conditions
Navigate manually (Manual Scroll) or automatically (AutoScroll) between Records during a Literature Session
Activate Voice Assistant during a Literature Session
Send Record(s) as SMS/MMS and or via Email and/or Network Messaging during a Literature Session
Bookmark Record(s) related to a Literature Session
Mark as “Favourite” or assign a Rating to the Record(s) related to a Literature Session
Print Record(s) related to a Literature Session
Repeat a Literature Session
Take a Literature Session with Repeated Criteria

FIG. 11 describes the System Operation of the Literature Session Module, explaining that the Module is based on user actions.

To invoke a Literature Session, the user first selects the Language in which Records for the Literature Session are to be brought forth. The Control System brings forth a User Interface from where the user can enter/select Criteria like Literature Session Title, No. of Records that the user wishes to appear in the Literature Session, and time of display per Record, specify none or one or more FIND conditions to find the Record(s) from the Database(s) to be used in the Literature Session, select to listen to a Background Music Sound File during the Literature Session, and start a Literature Session. The FIND conditions in this case are same as the ones described in FIG. 5.

After the user makes the necessary entries/selections and starts the Literature Session, the Control System brings forth a User Interface which displays the Literature Session, showing Record(s) found from the Database(s) according to the FIND conditions specified by the user, one after the other along with the time of display per Record as may be specified by the user. The Type of Literature under which the Record(s) may have been classified in the respective Module to which the Record(s) belong, is additionally displayed. In case the user enters the No. of Record(s) that the user wishes to appear in the Literature Session, that many Record(s) are randomly selected from the Database(s) according to the FIND conditions. Else, the Control System will bring forth all the available Record(s), which satisfy the FIND conditions, to be displayed in the Literature Session. From the User Interface, the user can view the details of the Record(s) displayed one by one. The user can further select whether or not to listen to the Background Music during the Literature Session at any point of time. The user can activate the Voice Assistant in order to receive Voice Output of the Record(s) displayed one by one. A character appears which speaks out the text of the Record(s) through an embedded text to speech engine. The Control System saves the Voice Output of a particular Record in an mp3 file format, as may be specified by the user in the Voice Output option described in FIG. 26. The user can select between either automatically or manually navigating between the Record(s). In case of automatic navigation, a Record is automatically displayed to the user for the time of display per Record as may be specified by the user. The Record(s) are thus displayed one by one to the user until all the Record(s) that are to appear in the Literature Session, as specified by the user, have been displayed. In case of manual navigation, the user can navigate back and forth between the Record(s). There is no time of display per Record in this case. The user can switch between automatic and manual navigation at any point of time during the Literature Session. The user can further select to view or play an Attached File, if any, of the Record(s) during the Literature Session. In case the Attached File is an Animation or Sound file, the Control System will invoke the relevant application, if installed on the user's computer system, to play the same. While in case if the Attached File is an Image file, the Control System automatically displays the same. The user can also send any Record(s) as SMS/MMS and or via Email and/or Network Messaging during the Literature Session. The user can, at any point of time, either choose to close the User Interface displaying the Literature Session, or choose to end the Literature Session.

If the user chooses to close the User Interface displaying the Literature Session, the Control System closes the User Interface, saves the Literature Session along with its Criteria, generates a new Literature Session Id, and thus updates the Database(s). The user then comes out of the Module.

If the user chooses to end the Literature Session, the Control System closes the User Interface displaying the Literature Session, saves the Literature Session along with its Criteria, generates a new Literature Session Id, and thus updates the Database(s). The Control System then brings forth a User Interface showing a grid which displays the Record(s) that were brought forth during the Literature Session, and from where the user can choose options like repeating the immediately preceding Literature Session, taking a Literature Session with same Criteria as that of the immediately preceding Literature Session, or taking a Literature Session with new Criteria. The user can further choose to print Record(s) of the immediately preceding Literature Session, print a Literature Session Report, or entire details of Record(s), as well as Bookmark and/or mark as “Favourite” and/or assign a Rating to the Record(s) of the immediately preceding Literature Session. The user can chose not to select any of these options and further close the User Interface to come out of the Module.

If the user chooses to repeat the immediately preceding Literature Session, the Control System starts the Literature Session by bringing forth a User Interface displaying the same, showing the same Record(s) as in the immediately preceding Literature Session. At the end of this Session, the Control System saves the same along with its Criteria, generates a new Literature Session Id, and updates the Database(s). The Control System will now treat this saved Literature Session as a separate Literature Session.

If the user chooses to take a Literature Session with same Criteria as that of the immediately preceding Literature Session, the Control System brings forth a User Interface from where the user can choose between selecting to take a Literature Session by excluding Record(s) that have already appeared in the immediately preceding Literature Session taken by the same Criteria, or selecting to take a Literature Session with all the Record(s) by the same Criteria as that of the immediately preceding Literature Session. The Control System starts a Literature Session by bringing forth a User Interface displaying the Literature Session, showing the Record(s) according to the user's selections. The Control System saves this Literature Session along with its Criteria, generates a new Literature Session Id, and thus updates the Database(s).

If the user chooses to take a Literature Session with new Criteria, the Control System brings forth a User Interface from where the user can enter/select Literature Session Criteria and start the Literature Session as described earlier. The Control System starts a Literature Session by bringing forth a User Interface displaying the Literature Session, showing the Record(s) according to the user's selections. The Control System saves this Literature Session along with its Criteria, generates a new Literature Session Id, and thus updates the Database(s).

If the user wishes to print the Record(s) of the immediately preceding Literature Session, the user can select all or specific Record(s) to be thus printed. The Control System brings forth the print previews accordingly from where the user can print further.

If the user chooses to Bookmark and/or mark as “Favourite” and/or assign a Rating to the Records(s) of the immediately preceding Literature Session, the user can select all or specific Record(s) to be thus flagged. The Control System flags and/or assigns a Rating to the Record(s) accordingly and thus updates the Database(s).

In case the user wishes to repeat a Literature Session that has been taken earlier, the user must first select the Language in which the user wishes to repeat a Literature Session. The Control System brings forth a User Interface showing a grid which displays all the Literature Session(s) taken earlier in the selected Language. The user can Sort the Literature Session(s) in the grid, in ascending or descending order, by Criteria like Literature Session Title, number of Record(s) appeared in the Literature Session, and Date on which the Literature Session was taken. The user can also view the Criteria by which the Literature Session(s) were taken. Further, if the user selects any Literature Session in the grid, the Control System displays the details of the Record(s) appeared in that selected Literature Session, in another grid. After the user selects the desired Literature Session, the Control System starts the Literature Session by bringing forth a User Interface displaying the same. After the end of this Literature Session, the Control System saves the same, generates a new Literature Session Id, and updates the Database(s). The utility(s)/functionality(s) provided by the Module after the end of a Literature Session, as described above, are also applicable in this case.

In case if the user wishes to take a Literature Session with the same Criteria as that of a Literature Session taken earlier, then the user must first select the Language in which the user wishes to do the same. The Control System brings forth a User Interface showing a grid which displays all the Literature Session(s) taken earlier for the selected Module in the selected Language. The general functionality(s) related to this User Interface like sorting the Literature Session(s), viewing the details of the same, are the same as those in the User Interface brought forth in case of repeating a Literature Session. After the user selects the desired Literature Session, the Control System brings forth a User Interface from where the user must choose between selecting to take a Literature Session by excluding Record(s) that have already appeared in the selected Literature Session taken by the same Criteria, or selecting to take a Literature Session with all the Record(s) by the same Criteria as that of the selected Literature Session. The Control System starts a Literature Session by bringing forth a User Interface displaying the same, showing the Record(s) according to the user's selections. The Control System saves this Literature Session along with its Criteria, generates a new Literature Session Id, and thus updates the Database(s). The utility(s)/functionality(s) provided by the Module after the end of a Literature Session, as described above, are also applicable in this case.

In case the user wishes to print the Record(s) appeared in a Literature Session that has been taken earlier, the user must first select the Language in which the user wishes to do the same. The Control System brings forth a User Interface showing a grid which displays all the Literature Session(s) taken earlier in the selected Language. The user can Sort the Literature Session(s) in the grid, in ascending or descending order, by Criteria like Literature Session Title, number of Record(s) appeared in the Literature Session, and Date on which the Literature Session was taken. The user can also view the Criteria by which the Literature Session(s) were taken. Further, if the user selects any Literature Session in the grid, the Control System displays the details of the Record(s) appeared in that selected Literature Session, in another grid. After the user selects the desired Literature Session for printing, the Control System brings forth a print preview of the Record(s) that appeared in that Literature Session from where the user can further print accordingly.

Note: The Literature Session(s) taken by a particular user who has logged into the System are not visible to any other user who logs into the same System at a different point of time.

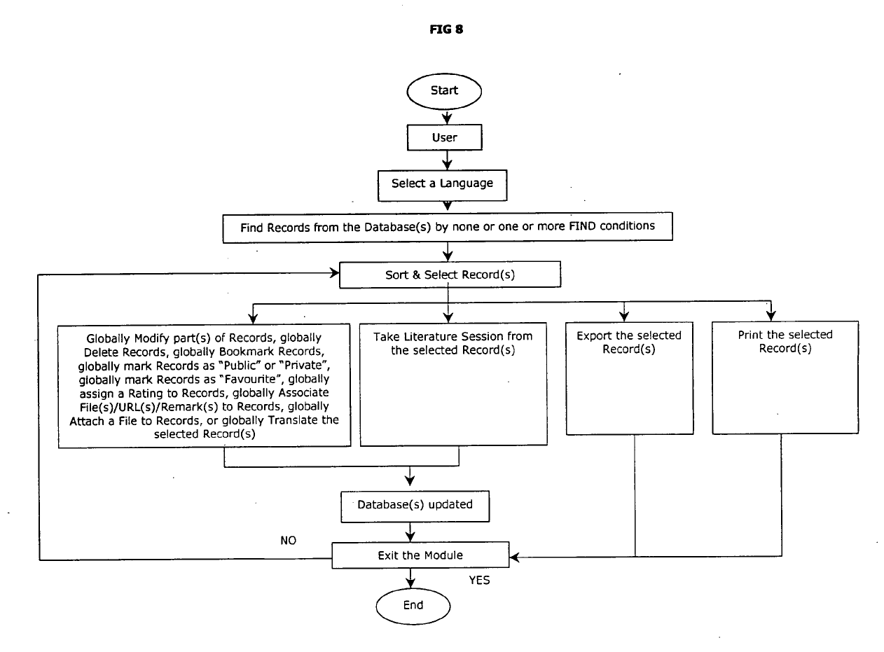

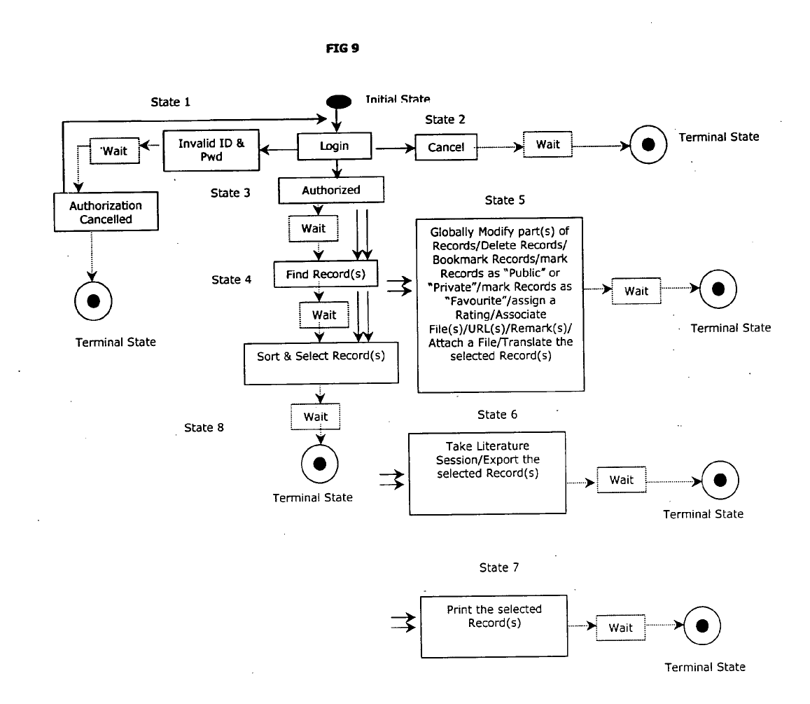

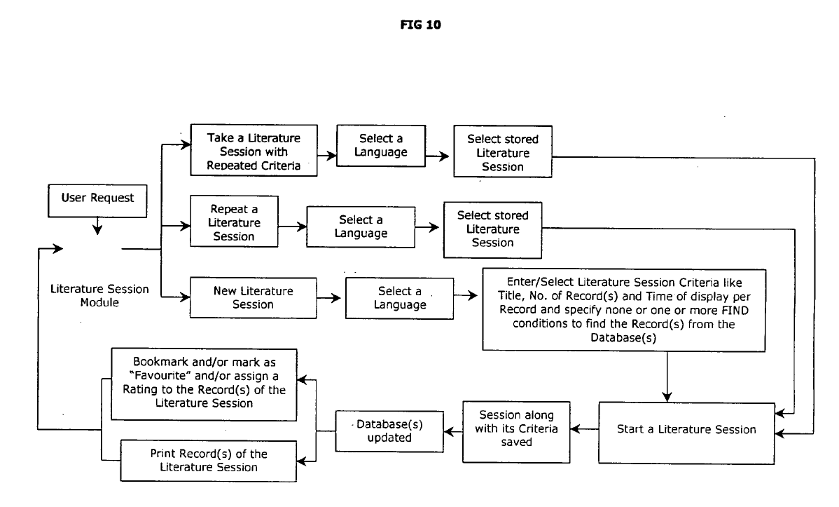

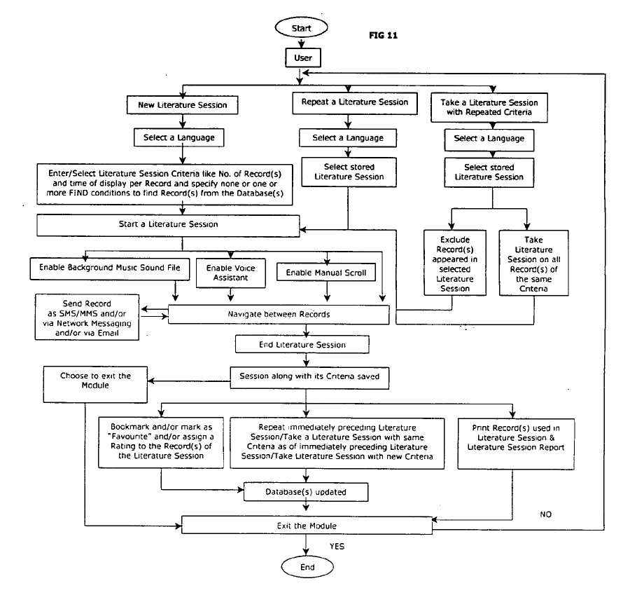

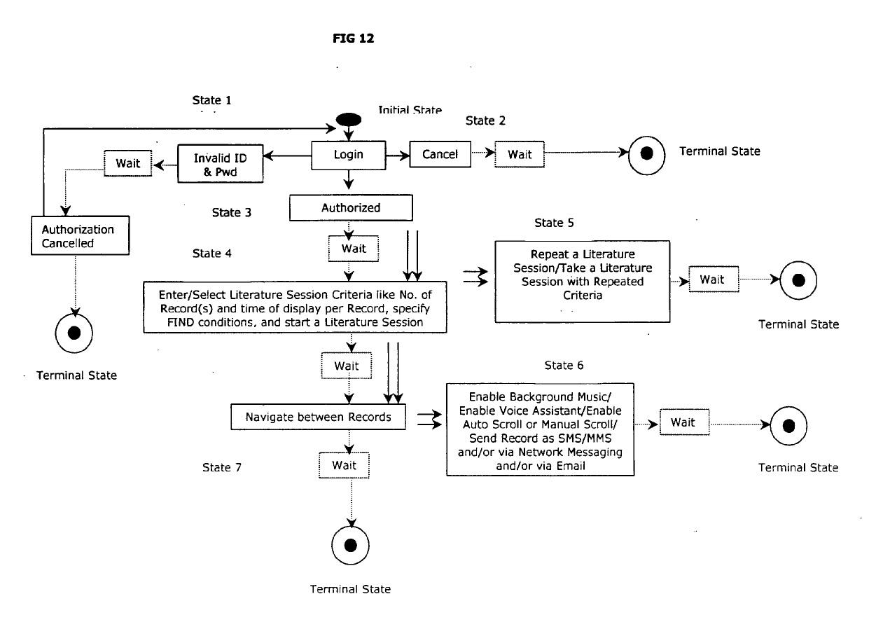

FIG. 12 describes the System State Transition of the Literature Session Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 13 to 15 explain the System Function, System Operation, and System State Transition respectively of the Reports Module which allows a user to obtain Reports and/or Graphs.

FIG. 13 is the diagram of the System Function of Reports Module of the present invention. The architecture of this Module comprises the following major functions, which allow a user to obtain Reports and/or Graphs with the help of the User Interface.

The Module allows a user to:
Select Language
Select a Report type
Select Criteria
Print Report/Graph with or without the details of the selected Criteria by using Record(s) found from the Database(s) by none or one or more FIND conditions, pertaining to the selected Report, in the selected Language

FIG. 14 describes the System Operation of Reports Module, explaining that the Module is based on user actions.

When the user enters this Module, the Control System brings forth a User Interface from where the user must first select the Language in which the user wishes to obtain the Report. The User Interface displays a list of all the available types of Reports along with a brief description about each Report. The Reports Module allows the user to obtain the following Reports like:
List of Records
Alphabetical Index of Record(s)
Count of Records by Classification(s)
User Details
Record usage report
Record details report

The user then selects one of these Report types for printing. The Control System, depending on the type of Report selected, either brings forth a print preview of the Report from where the user can directly print the Report or brings forth a User Interface wherein the user must enter/select some Criteria beforehand and then the Control System brings forth the print preview of the Report by using Record(s) found from the Database(s) by the Criteria specified by the user. The user comes out of the Module by closing either the print preview or the User Interface mentioned.

FIG. 15 describes the System State Transition of the Reports Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 16 to 18 explain the System Function, System Operation and System State Transition respectively of the Export Module which provides the user with the utility of Exporting Records (by means of a Database file created by the System) stored in the Database(s), by finding the same from the Database(s) based on none or one or more FIND conditions,

FIG. 16 is the diagram of the System Function of Export Module of the present invention. The architecture of this Module comprises of the following major functions, which allow a user to Export Record(s) stored in the Database(s), with the help of the User Interface.

The Module allows a user to:
Select the Language
Find existing Record(s) from the Database(s) by none or one or more FIND conditions
Sort and Select Record(s)
Validate Data
Export selected Record(s) as Database File and/or via Email and/or Network Messaging.

FIG. 17 describes the System Operation of Export Module, explaining that the Module is based on user actions.

When the user enters this Module, the Control System brings forth a User Interface from where the user must select the Language in which the Record(s) to be exported are to be brought forth. The User Interface further allows the user to choose whether or not to send flags like Bookmark, and/or ‘Favourite’, if any, along with the Record(s) to be exported. —EXAMPLE—If the exporting user is exporting Record(s) which have been Bookmarked, the user has an option of selecting whether or not to send the Bookmarks and associated Bookmark Remarks along with such Record(s) to be exported. If the exporting user selects to send the Bookmarks and associated Bookmark Remarks, then the importing user is allowed to see that the Records(s) have been bookmarked and can further view and modify the Bookmark Remarks associated with the bookmarked Record(s). Else, the importing user cannot see that the Records(s) have been bookmarked. The same applies in case the user wishes to send the ‘Favourite’ flag. The exporting user can choose to send either particular flag(s), all flags, or none of the flags with the Record(s) to be exported. The user can also undo selections of the same. The flags that are chosen to be sent along with the Record(s) to be exported are those set by the user who has logged in to the System. After the user has chosen whether or not to send the desired flags, the Control System brings forth a User Interface from where the user can find Record(s) to be exported, from the Database(s) by none or one or more FIND conditions. The FIND conditions in this case are same as the ones described in FIG. 5. The Control System brings forth a User Interface, displaying the Find Results in a grid, and from where the user can Sort and Select the Record(s) to be exported. The Sort and Select, including ‘Selected So Far’, functionalities in this case are same as the ones described in FIG. 5. The User Interface provides the user with the same utility(s)/functionality(s) applicable to Record(s) in a Find Result grid as described in FIG. 5. The user can also view the Classification details of the selected Record(s) or those of the entire set of found Record(s). If the user chooses to Export the selected Record(s), the Control System performs a Data Validation in that it checks whether the data that the user wishes to be exported, is exportable or not. If the selected Record(s) meet the Criteria of the Data Validation, the Control System allows these Record(s) to be exported. Else, the Control System notifies the user that the Record(s) cannot be exported. After Data Validation, the Control System brings forth a User Interface from where the user must browse for and select the appropriate file/folder destination on a computer system where the user wants to Export. After this selection, the user can Export the selected Record(s) as a Database File and/or via Email and/or Network Messaging. The Control System creates a Database file using the selected Record(s) at the file/folder destination on a computer system as specified by the user and notifies the user that the selected Record(s) were successfully exported and also displays the number of Record(s) exported. The Control System adds the User Details of the exporting user to the Record(s) in the Database file. These User Details can be viewed and further modified by the importing user through the User Interface showing the import Remarks, which is described in FIG. 20. After this, the Control System takes the user back to the User Interface from where the user can further Sort, Select, and Export Record(s). If the user closes this User Interface, the Control System gets notified and the user comes out from the Module.

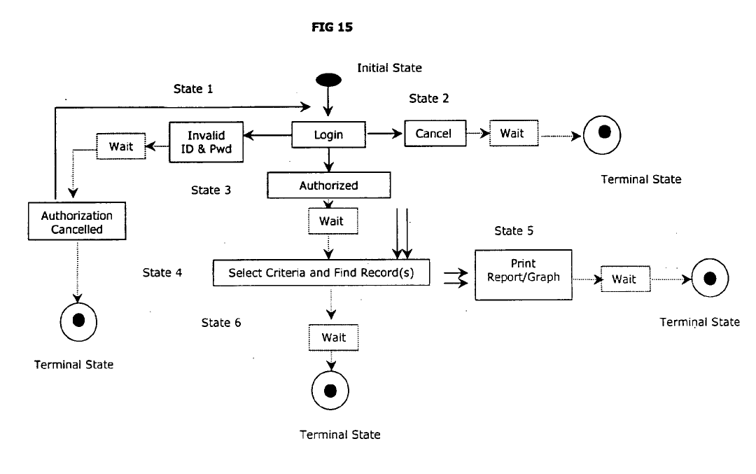

FIG. 18 describes the System State Transition of the Export Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 19 to 21 explain the System Function, System Operation and System State Transition, respectively, of the Import Module which provides the user with the utility of Importing Records from a Database file that may have been created by other user(s) of this System, with the utility of appending to the data already stored by the user in the Database(s).

FIG. 19 is the diagram of the System Function of Import Module of the present invention. The architecture of this Module comprises the following major functions, which allow a user to Import Record(s) from a Database file that may have been created by other user(s) of this System, with the help of the User Interface.

The Module allows a user to:
Browse for and select a File
Validate the File
Get Record(s)
Sort and Select Record(s)
Import Record(s)

FIG. 20 describes the System Operation of Import Module, explaining that the Module is based on user actions.

When the user enters this Module, the Control System brings forth a User Interface from where the user must browse for and select the appropriate file on a computer system from which the user wants to Import Record(s). After this selection, the Control System verifies whether the file selected by the user is a valid Database file or not. If the file selected by the user is not a valid Database file, then the Control System notifies the user that the file is invalid and hence can't be imported. Else, the Control System brings forth a User Interface displaying all the Record(s) in the Database file in a grid, and from where the user can further Sort and Select the Record(s) to be imported. The Sort and Select functionalities are same as the ones described in FIG. 5. The user can select to import, the Record(s) which the user has highlighted, the entire set of Record(s) displayed in the grid facing the user, or the entire set of Record(s) in the Database file. The user can also undo these selections. The user can further view the selected Record(s) through a ‘Selected So Far’ utility, wherein the Control System brings forth a User Interface from where the user can view the selected Record(s) as well as Sort and make further selections or undo selections of the same. If the user chooses to import the selected Record(s), the Control System brings forth a User Interface from where the user can add/modify Import Remarks, and choose whether or not to import flags like Bookmark (and associated Bookmark Remarks) and/or “Favourite” along with the Record(s). These flags have been set by the exporting user who has created the Database file by the export activity described in FIGS. 16 and 17. The data input field for Import Remarks in the User Interface, shows by default, the name of the exporting user and the date on which the Database file, which the user has selected to Import Record(s), was created. This feature helps the user to keep track of the Records received from a particular exporting user, for the purpose of future reference. The user can further modify these Import Remarks and add more Import Remarks as desired. These Import Remarks can be seen and further modified through the Literature Bank Module described in FIGS. 4 and 5, into which the Record(s) are imported. The user can also choose to import the selected Record(s) without adding any Import Remarks. After the user has chosen to import the selected Record(s), the Control System appends the Record(s) to the Database(s) according to the Module to which the Record(s) belong. After importing, the Control System updates the Database(s) and notifies the user that the selected Record(s) were successfully imported and also displays the number of Record(s) imported. After this, the Control System takes the user back to the User Interface from where the user can further Sort and Select Record(s) to be imported. If the user closes this User Interface, the Control System gets notified and the user comes out from the Module.

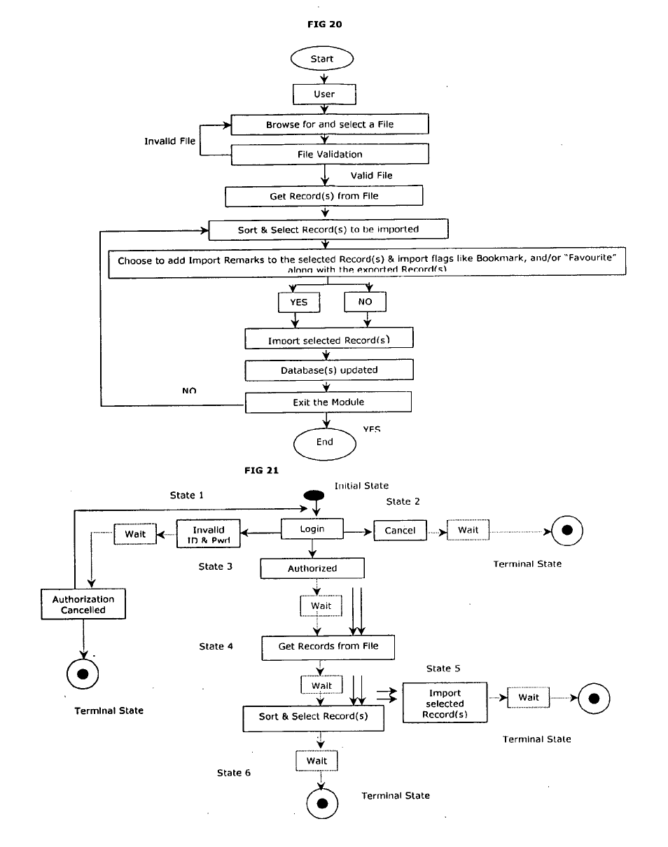

FIG. 21 describes the System State Transition of the Import Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

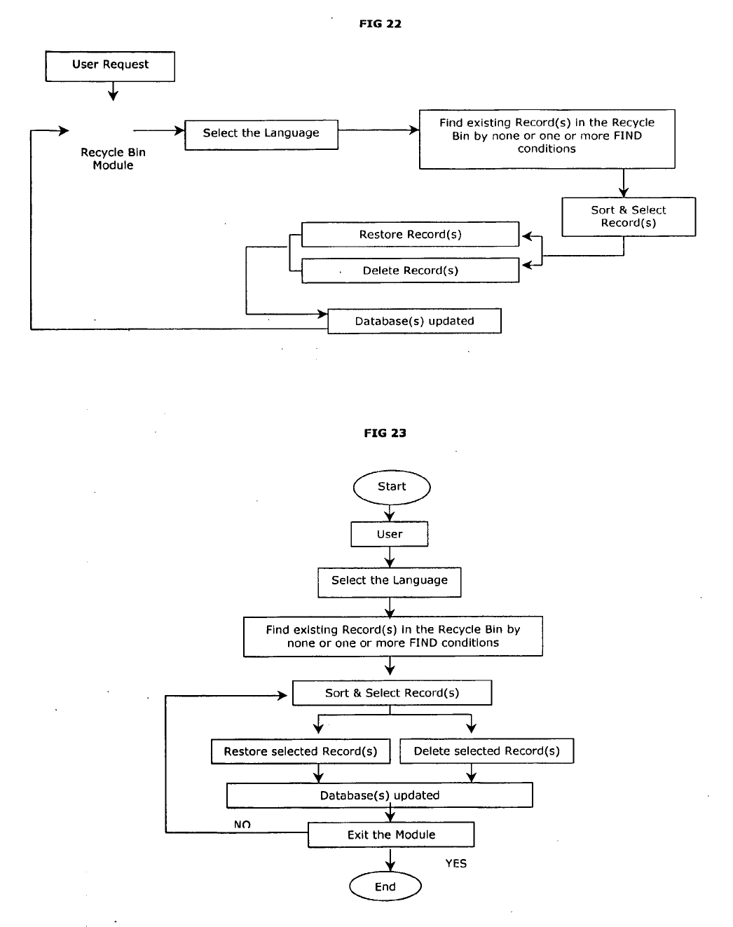

FIGS. 22 to 24 explain the System Function, System Operation and System State Transition respectively, of the Recycle Bin Module which allows the user to Restore or Permanently Delete Record(s), which may have been deleted by the user.

FIG. 22 is the diagram of the System Function of Recycle Bin Module of the present invention. The architecture of this Module comprises of the following major functions, which allow a user to Restore/Permanently Delete Record(s) with the help of the User Interface.

The Module allows a user to:
Select the Language
Find existing Record(s) in the Recycle Bin of the System, by none or one or more FIND conditions
Sort and Select Record(s)
Restore/permanently Delete selected Record(s)

FIG. 23 describes the System Operation of the Recycle Bin Module of the present invention explaining that the Module is based on user actions.

When the user first enters this Module, the Control System brings forth a User Interface from where the user must select the Language in which the Record(s) to be Restored or Permanently Deleted are to be brought forth. The User Interface also allows the user to find the Record(s) that have been deleted earlier and are lying in the Recycle Bin of the System, by none or one or more FIND conditions. The FIND conditions in this case are the same as the ones described in FIG. 5. The Control System brings forth a User Interface displaying the Find Results showing the Record(s) which have been deleted by the user, in a grid, and from where the user can further Sort and Select the Record(s) to be Restored or permanently Deleted. The Sort and Select, including ‘Selected So Far’, functionalities in this case are same as the ones described in FIG. 5. The user can also view the Classification details of the selected Record(s) or those of the entire set of found Record(s). The user can also print the selected Record(s). After the user selects the Record(s), the user can choose to either Restore or permanently Delete the Record(s). In both cases, the Control System prompts the user as to whether or not the user wants to Restore or permanently Delete the selected Record(s). If the user chooses to Restore the selected Record(s), the Control System takes the selected Record(s) out of the Recycle Bin and restores them back to the Literature Bank Module with their original Record Id(s). If the user chooses to permanently Delete the selected Record(s), the Control System deletes the selected Record(s) from the Recycle Bin and thus permanently removes the Record(s) from the Database(s). Sufficient care is exercised by the Control System to ensure that Record(s) that are in use, in existing Literature Session(s), are not permanently deleted. —EXAMPLE—If certain Record(s) in the Recycle Bin are in use in existing Literature Session(s) and if the user chooses to Delete them, then the Control System notifies the user that the Record(s) are in use, and hence cannot be permanently deleted.

Whenever Record(s) are Restored or Deleted, the Control System updates the Database(s) and notifies the user that the selected Record(s) were successfully Restored or Deleted and also displays the number of Record(s) Restored or Deleted. After this, the Control System takes the user back to the User Interface from where the user can further Sort and Select Record(s) to be Restored or Deleted. This User Interface further allows the user to print and/or Export the selected Record(s) displayed in the grid in the same manner as described in FIG. 5. If the user closes this User Interface, the Control System gets notified and the user comes out from the Module.

FIG. 24 describes the System State Transition of the Recycle Bin Module of the System explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

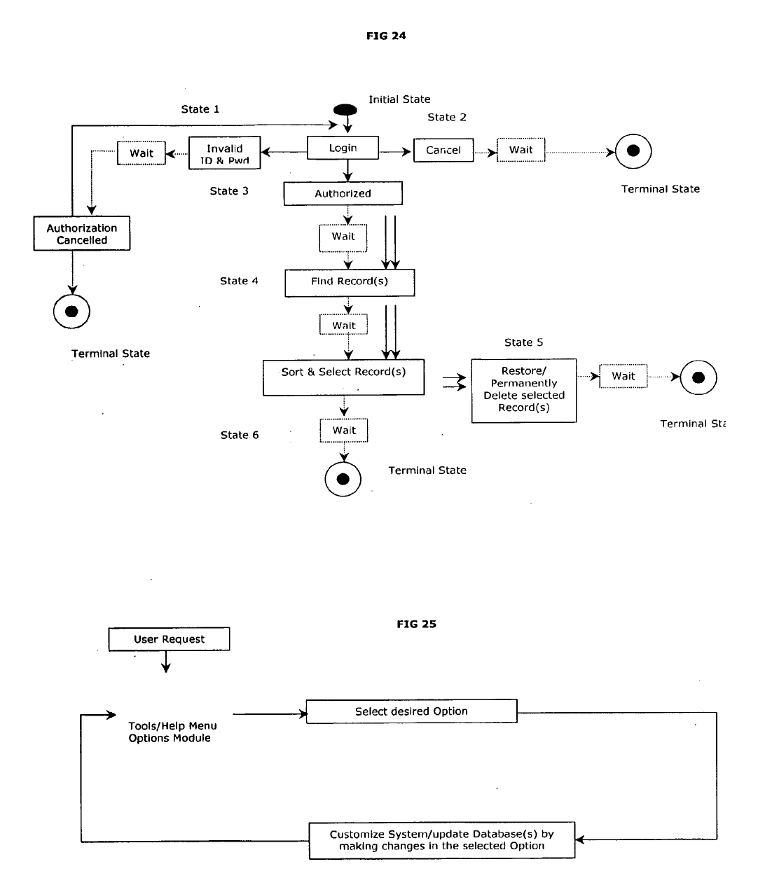

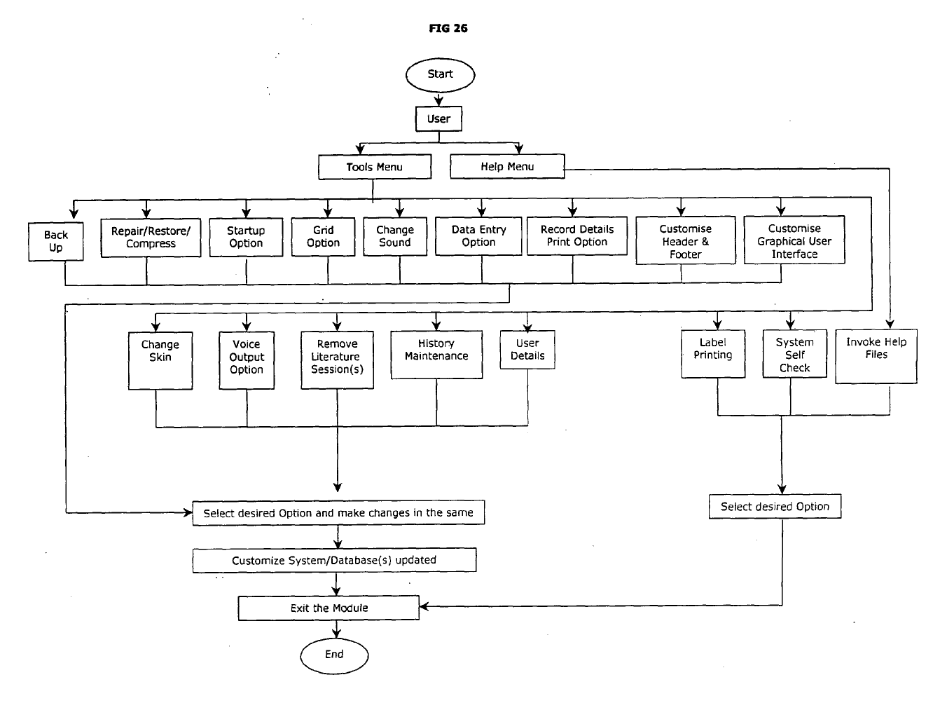

FIGS. 25 to 27 explain the System Function, System Operation and System State Transition respectively, of the Tools/Help Menu Options Module comprising of maintenance Tools such as Back Up, Repair, Restore, Compression of the entire Database(s) and System Self Check. There are other tools such as Start Up Option, Grid Option, Change Sound, Data Entry Option, Label Printing, Record Details Print Option, Customize Header and Footer, Customize Graphical User Interface, Change Skin, Voice Output Option, Remove Literature Session(s), History Maintenance, User Details, and Help.

FIG. 25 is the diagram of the System Function of Tools/Help Menu Options Module of the present invention. The architecture of this Module comprises of the following major functions, which allow a user to select any option for Customization including maintenance of the System and updating of Database(s).

The Module allows a user to:
Select any option
Customize the System/Update Database(s) by making changes in the selected option.

FIG. 26 describes the System Operation of the Tools/Help Menu Options Module, explaining that the Module is based on user actions. Through this Module, the user can select any of the options mentioned below for customization and maintenance of the System.

The Tools/Help Menu Options Module, through the User Interface, retrieves and brings forth the following utilities which the user can select:
Back Up—This utility allows the user to back up the Database(s). If the user selects this utility, the Control System brings forth a User Interface from where the user must browse for and select the appropriate file/folder destination on the user's computer system, where the user wants to take the backup. The Control System backs up the entire Database(s) and creates a backup at the selected file/folder destination.
Restore—This utility allows the user to restore the Database(s) from a backup taken by the user by using the Back Up utility. If the user selects this utility, the Control System brings forth a User Interface from where the user must browse for and select the appropriate file/folder destination on the user's computer system, where the user has taken the backup. The Control System restores the Database(s) with the backup accordingly.
Repair and Compress—This utility allows the user to repair and compress the Database(s).
System Self Check—This utility allows the user to initiate a System Self Check. If the user selects this utility, the Control System gets notified and initiates a System Self Check. The Control System notifies the user whether the System Self Check has completed successfully or not, and further generates a Report displaying the tasks performed during the System Self Check.
Start Up Option—This utility allows the user to set conditions like the Login User Interface and Quick Start User Interface to appear each time the System is initiated. If the user selects this utility, the Control System allows the user to select either or both the Login and the Quick Start User Interfaces to appear each time the System is initiated. The Control System updates the Database(s) in this case.
Grid Option—This utility allows the user to enter the number of Record(s) to be displayed in a Find Result grid at a time, facing the user. —EXAMPLE—If the user enters 24, then 24 Record(s) will be displayed in any Find Result grid at a time, facing the user. This utility further allows the user to choose whether or not the Control System should remember the current FIND criteria entered and/or selected by the user when the user chooses to find Record(s) from the Database(s). The Control System updates the Database(s) in this case.
Change Sound—This utility allows the user to change sounds like the background sounds which are used in a Literature Session(s). If the user selects this utility, the Control System brings forth a User Interface which displays the sound files for background sounds selected by the user, and further allowing the user to browse for and select the appropriate sound files for background sounds. The user can further play the sound files thus selected by the user for the background sounds. The user can also select the sound files specified as default for background sounds. The Control System updates the Database(s) in this case.
Data Entry Options—This utility allows the user to enable/disable the “Copy Current Entry” functionality during data input, as well as allowing further customization of the same. The “Copy Current Entry” functionality is described in FIG. 5. If the user selects this utility, the Control System brings forth a User Interface, from where the user must first select whether to have “Copy Current Entry” functionality during data input or not, as well as select the data input fields to be copied using this functionality. The Control System updates the Database(s) in this case.
Label Printing—This utility allows the user to print user information labels.
Record Details Print Option—This utility allows the user to customize the Criteria for printing Details of a Record. If the user selects this utility, the user must first select the Language. The Control System brings forth a User Interface from where the user can select the part(s) of a Record that are to be printed. The user can also undo all of these selections. The Control System updates the Database(s) in this case.
Customize Header and Footer—This utility allows the user to customize the Header and Footer for the Printed outputs. If the user selects this utility, the Control System brings forth a User Interface from where the user can enter the appropriate Header and Footer details which will appear in all the Reports. The Control System updates the Database(s) in this case.
Customize Graphical User Interface—This utility allows the user to change the Labels that appear on the User Interface. The Control System updates the Database(s) in this case.
Change Skin—This utility allows the user to select the “skins” for the User Interface. If the user selects this utility, the Control System brings forth a User Interface from where the user can browse for and select the desired “skin” file. The user can also set a “skin” file as the default “skin”. The user can also undo these selections. The Control System updates the Database(s) in this case.
Voice Output Option—This utility allows the user to select the part(s) of a Record of which the user wishes to receive Voice Output as well as save the Voice Output of a particular Record in an mp3 file format. If the user selects this utility, the user must first select the Module for which the user wishes to customise this utility and then select the Language. The Control System brings forth a User Interface from where the user can select all or specific part(s) of a Record of which the user wishes to receive the Voice Output. The user can further select to save the Voice Output of the Record, either received from the Literature Bank Module and/or from a Literature Session, in an mp3 file format, and further browse for and select the appropriate file/folder destination on a computer system where the user wishes to save the mp3 file. The Control System updates the Database(s) in this case.
Remove Literature Session(s)—This utility allows the user to permanently remove previously taken Literature Sessions, such deletions capable of being made selectively. If the user selects this utility, the user must first select the Language. The Control System brings forth a User Interface showing a grid which displays all Literature Session(s) taken earlier in the selected Language. The user can Sort the Literature Session(s), in ascending or descending order, by various Classifications. The user can further select all or specific Literature Session(s) from the grid, to be removed from the System. If the user chooses to remove the selected Literature Session(s), then the Control System prompts the user as to whether or not the user wants to remove the selected Literature Session(s). If the user chooses to continue, the Control System removes the selected Literature Session(s) from the System and notifies the user about the same. The Control System updates the Database(s) accordingly.
History Maintenance—This utility allows the user to delete the History for a certain Record in the Database(s). The Control System maintains a History of each Record in the Database(s) in terms of Criteria such as its Record Id, the user who has created it, the Language in which the Record was created, whether or not the Record has appeared in a Literature Session, the frequency by which the Record appeared in the same, Date and time of the same. The Control System updates the Database(s) in case the user deletes the History of Record(s).
User Details—This utility allows the user to enter or modify the user details like User Name and Password. The user can create Sub users through this option. The Control System updates the Database(s) accordingly.
Help—This utility allows the user to invoke the Help files, which provide Help on how best to use the System.

After selecting any of the options mentioned above and customising or using the same, the user comes out of the Module.

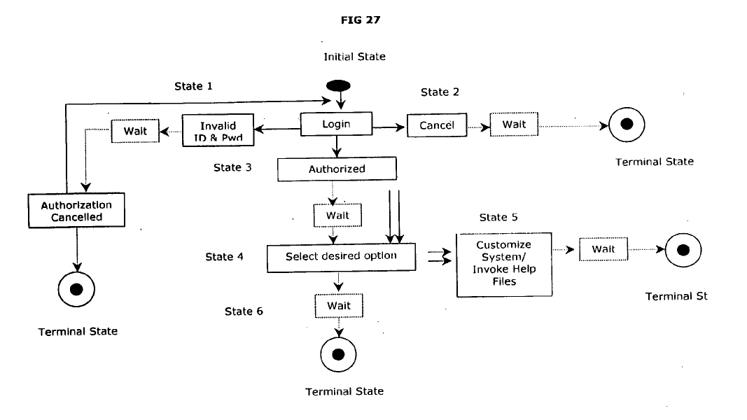

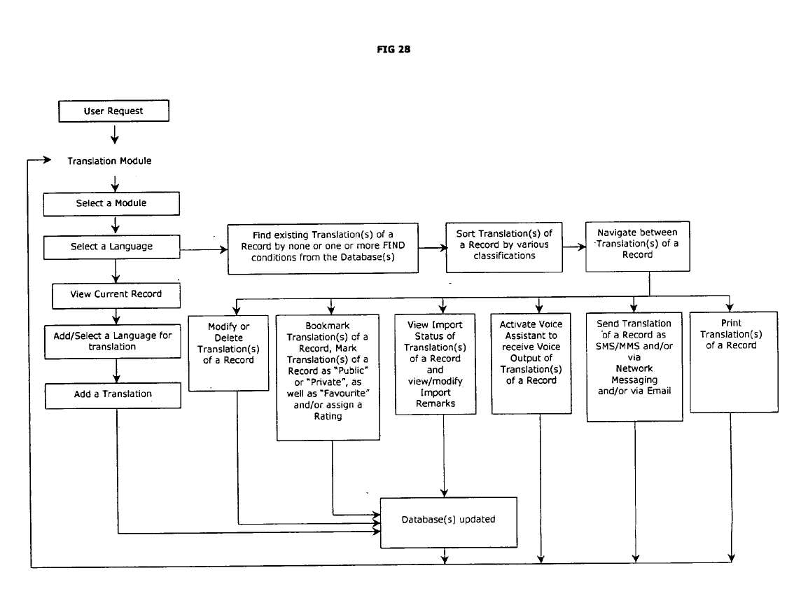

FIG. 27 describes the System State Transition of the Tools/Help Menu Options Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 28 to 30 explain the System Function, System Operation and System State Transition respectively of the Translation Module of the present invention. The Translation Module allows the user to consider any Record as a parent language Record and Translate the same into one or more languages of the user's choice, and further all of the features and/or utility(s)/functionality(s) available in case of the parent language Record would be available in case of its Translation.

FIG. 28 is the diagram of the System Function of the Translation Module of the present invention. The architecture of this Module comprises of the following major functions, which allow a user to consider any Record as a parent language Record and Translate the same into one or more languages of the user's choice.

For the purpose of the Translation activity, the user:
Finds Record(s) from the Database(s) by none or one or more FIND conditions
Sorts and Selects Record(s)
Selects/Adds a language
Adds Translation(s)
Modifies Translation(s)
Deletes Translation(s)
Prints Record(s) by various Print conditions

FIG. 29 describes the System Operation of Translation Module explaining that the Module is based on user actions. The Translation Module is invoked in any data input Module like the Literature Bank Module.

The user first enters the Module for the Records of which the user wants to Translate. The Control System brings forth the User Interface of this Module from where the user can choose to Translate a Record. If the user continues, then the Control System brings forth the User Interface of the Translation Module wherein the user must enter/select a Language and enter the translation in that Language, in data input fields which correspond to those of the Record facing the user considered as the parent Language Record. All the utility(s)/functionality(s) available in case of the parent Language Record are also available in case of its Translation. If the user chooses to save the Translation, the Control System saves the same as a Record in the Database(s), generates a new Record Id, and updates the Database(s). The user can find existing Translation(s) of a Record by none or one or more FIND conditions. The user can further Modify or Delete an existing Translation of a Record, in the same manner as in case of a normal Record. The user comes out of the Translation Module by closing the User Interfaces.

FIG. 30 describes the System State Transition of the Translation Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 31 to 33 explain the System Function, System Operation and System State Transition respectively, of the Master Module which provides the utility of creating, editing, deleting, printing, navigating, finding Masters like: User, Language, Source of Information, Type of Literature, Age Group, Genre and Sub Genre, Author/Poet, Publisher. Sufficient security is provided by the System, so as not to allow the deletion of any Master of a Record that may be in use.

FIG. 31 is the diagram of the System Function of the Master Module of the present invention. The architecture of this Module comprises of the following major functions, which allow a user to create and store Masters for Criteria with the help of the User Interface.

The Module allows a user to:
Select Criteria
Select Language
Add Master(s) for the selected Criteria
Copy Current Entry
Find existing Master(s) from the Database(s)
Sort and Select Master(s)
Modify Master(s)
Delete Master(s)
Go To a Master and Navigate between Masters
Print Master(s)

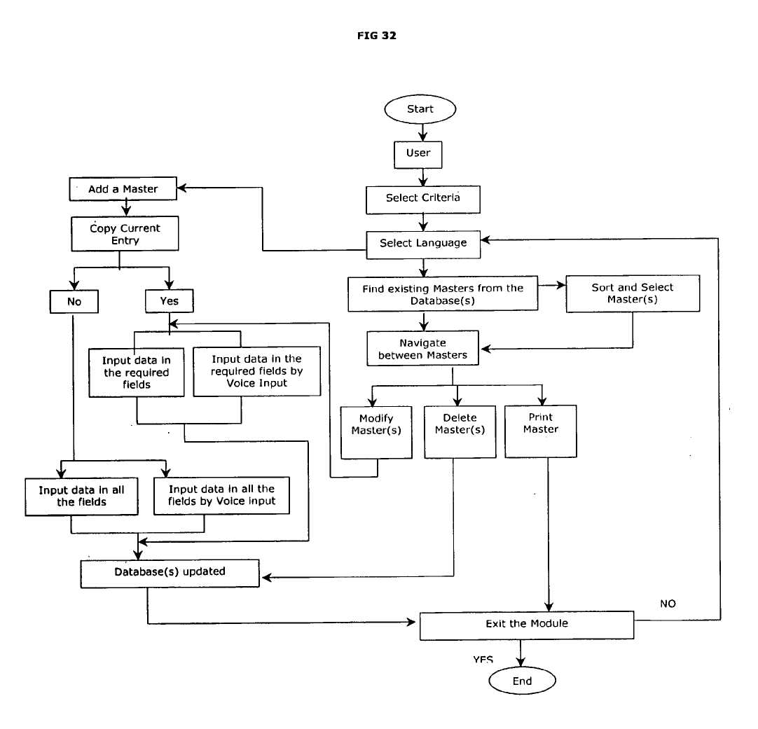

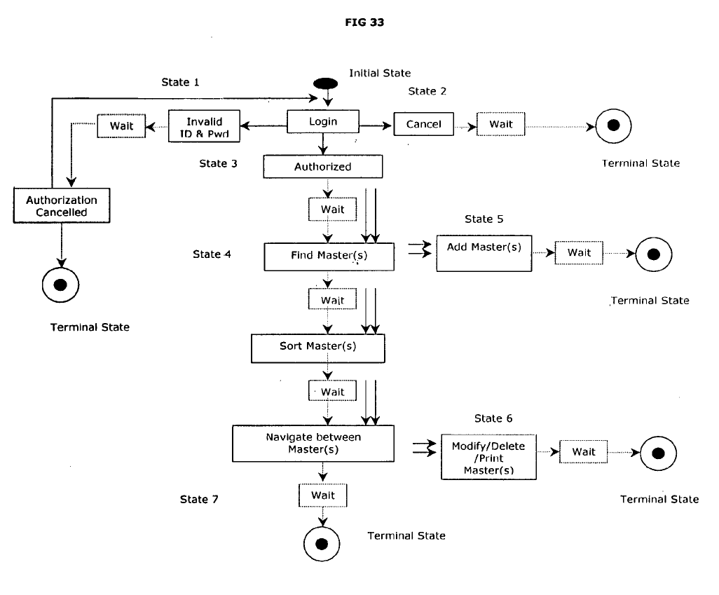

FIG. 32 describes the System Operation of the Master Module explaining that the Module is based on user actions. The Master Module accepts data in one or more languages (such data capable of being accepted from more than one user at the same time).

The user first selects the desired Criteria like User, Language, Source of Information, Type of Literature, Age Group, Genre and Sub Genre, Author/Poet, Publisher for which the user wishes to create, find, modify, delete, print Masters, and then the Language in which the user wishes to do the same. The Control System brings forth a User Interface from where the user can Create Master(s), Find Master(s), Modify Master(s), Delete Master(s), Navigate between Master(s), Print Master(s), for the Criteria selected by the user. All of these functionalities are described below in detail.

The Create Master functionality allows the user to create a Master for the selected Criteria by allowing data input in the fields provided for the purpose in the User Interface described above. When the user chooses to create a Master, the Control System prompts the user as to whether or not the user wishes to copy the current Master, if any, facing the user. If a user chooses not to use this “Copy Current Entry” utility, then the Control System gets notified and blanks out the relevant data input field(s) for new data input by the user. The user can then enter data in the relevant data input field(s) as desired. After the user creates a new Master and chooses to save it, the Control System checks whether the new Master created by the user is a duplication of any Master created earlier. If the created Master is a duplication, then the Control System notifies the user that the user cannot create duplicate Masters and does not allow the user to save the Master. Else, the Control System saves the Master and updates the Database(s). The user can now use this Master for the selected Criteria at the time of adding or modifying Record(s) in any data input Module like Literature Bank Module. The user can also create Masters by entering the same in the relevant data input fields when the user is adding or modifying Record(s) in any data input Module. The Masters thus created are also visible to the user through the Master Module. —EXAMPLE—If the user creates Masters through the Master Module for the Criteria of Genre and Sub Genre as GENRE>FICTION>SUB GENRE>SCIENCE FICTION, then these Masters like FICTION and SCIENCE FICTION for Genre and Sub Genre are available to the user, when the user is adding or modifying a Record in any data input Module. Conversely, if the user when adding or modifying a Record in any data input Module, creates Masters like the ones described above for Genre and Sub Genre by entering the same in the relevant data input fields, then these Masters would be visible to the user in the Master Module. The Control System also updates the Database(s) in this case. If the user imports a Record into any data input Module, the Masters contained in the relevant Record will also be visible to the user through the Master Module. The Control System also updates the Database(s) in this case. The Control System generates a new Record Id each time a new Master is created and saved by the user in either of the ways described above or when a Record is imported by the user which contains relevant Masters for Criteria like User, Language, Source of Information, Type of Literature, Age Group, Genre and Sub Genre, Author/Poet, Publisher.

The Voice functionality allows the user to create and/or Modify Master(s) by Voice

Input as well as receive Voice Output of the Master(s). In case the user chooses to receive Voice Output of the Master(s), the Control System brings forth a text to speech agent that speaks out the Master(s). The user can choose between listening to the text to speech agent speak out the Master(s) continuously or one Master at a time.

The Find functionality allows the user to find existing Master(s) stored in the Database(s). If the user chooses to use this functionality, then the Control System brings forth a User Interface from where the user can find Master(s) by entering keywords. —EXAMPLE—If there is a Master ‘JUNIOR’ for the Criteria of Age Group stored in the Database(s) and the user types in just ‘JU’, then the ‘JUNIOR’ Master will appear in the Find Results. The same applies in case the user enters any part of the word ‘JUNIOR’ as a keyword. If the user does not enter any keyword and chooses to Find Master(s), then the Control System brings forth Find Results showing all the Master(s) stored in the Database(s) for the selected Criteria. If a keyword entered by the user is not there in any of the Master(s), then the Control System notifies the user that no Master(s) have been found for the keyword entered by the user. The Control System brings forth a User Interface displaying the Find Results in a grid, from where the user can further Sort and group, the Masters currently displayed in the Find Result grid facing the user or the entire set of found Masters.

The Modify functionality allows the user to Modify a Master stored in the Database(s). If the user chooses to use this functionality then the user can use all the utility(s)/functionality(s) available at the time of creating a Master. After modification, if the user chooses to save the modification done to the Master, the Control System saves the same accordingly and updates the Database(s). Else, the modifications made by the user to the Master will not be saved. The modifications made by the user to the Master will be reflected in all the Record(s) which use that Master, in any data input Module and/or in any Literature Session(s).

The Delete functionality allows the user to Delete an existing Master stored in the Database(s). If the user chooses to use this functionality, the Control System prompts the user as to whether or not the user wishes to Delete that particular Master. If the user chooses to delete the Master, the Control System deletes the Master permanently from the System. The Control System updates the Database(s) in this case. However, if the Master to be deleted is being used by any Record in any data input Module and/or in any Literature Session(s), the Control System notifies the user that the Master is in use and hence cannot be deleted.

The Navigation functionality allows the user to navigate between the Masters stored in the Database(s).

The Printing functionality allows the user to print Master(s) stored in the Database(s).

If the user closes the User Interface described above, the Control System gets notified and the user comes out from the Module.

FIG. 33 describes the System State Transition of the Master Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

### TECHNICAL APPLICATION TO THE INDUSTRY

The invention has several technical applications for the education and publishing industries. The invention has the potential to change the way in which works of literature are built, stored, modified and shared in the education and publishing industries.
1) The invention allows users to constantly modify data as per their requirement, with a minimum amount of effort. This would be a very helpful and time-saving utility, for authors and/or editors who often review and edit their work several times.
2) The invention facilitates ease of retrieval of data from the databank, using a powerful Find utility that allows users to quickly search through a large database for specific data. Since the information is well classified, and available in one container, it eliminates the necessity of having to create and sort through many files and/or documents, thus reducing the time spent on such an activity.
3) The invention allows users to build a personalized and well-classified databank of works of literature, with the possibility of additional information being stored. This would be useful for authors who can create and store works of literature based on a particular subject or a topic. Further, it would also be of help to people to store selected works of literature according to their personal requirements. This would also be of immense use to publishers of works of literature, who could release specialized editions as per special guidelines and/or market requirements.
4) The invention also facilitates the sharing of data, through an Export/import module. This utility can encourage the exchange of data between different persons, organizations, or institutions, regardless of their physical location, thus helping create a larger common repository of knowledge for a wider audience.
5) The invention further allows a user to translate data from one language into another of the user's choice. This is particularly useful in case of authors who want to create works of literature in various languages, and further in case of publishers when they plan to publish works of literature in various languages.

The invention has many other useful features, such as allowing users to attach and associate audio-visual files in order to create more comprehensive data. The invention is also capable of distributing information through various mass media. Moreover, the invention has a provision for safeguarding confidential/proprietary content and prevents accidental deletion of the same.

### Mass-Media and the Invention:

The use of the invention to the publishing industry can be optimized by exploring the potential of mass media. This can be seen as follows:—
1) Publishing/Printing: The invention could be used by publishers for the regular publishing of works of literature. Moreover, since the invention allows a detailed classification of data, works of literature based on a particular subject or topic can be published with ease, for example, “Selected works of William Shakespeare”.
2) The Internet: The invention can be used to create a repository of works of literature to be used by all kinds of websites, either general in nature or focusing specifically on works of literature. In addition, it can also be used to send and receive works of literature via E-mail and/or Network Messaging.
3) Mobile Services: The invention can be used to create a repository of works of literature such as poems, verse, rhymes, limericks, jingles, and such others which can be offered as Value Added Services, by mobile service operators. The popularity of SMS/MMS would ensure a large audience for such works of literature, thus adding another dimension to these services.
4) Television, Radio & Films: The invention can be used a repository of scripts and/or screenplays for films, television, and radio programmes.

What is claimed is:

1. An interactive system for building, organizing, and sharing one's own databank of works of literature including novels, short stories, poems, essays, scripts, rhymes, theses, verse, composition, manuscripts, transcripts, articles, in one or more languages, using a computer system, said interactive system comprising:
i) a user interface;
ii) one or more well-classified databases to store data user wise including a literature bank database, a translation database, a user database, and a configuration database;
iii) at least one well classified literature bank module to input, organize and manage one's own databank of works of literature in the form of data/record(s) in the databases;
iv) modules for sharing, invoking, and/or customizing the literature data/record(s) in the databank for continuous entertainment/enjoyment and/or improvement of one's knowledge on works of literature such as novels, short stories, poems, essays, scripts, rhymes, theses, verse, composition, manuscripts, transcripts, articles; and
v) a control system acting as a bridge between the modules and the databases to display relevant data/record(s) on the user interface by finding the same from the databank, based on none or one or more “FIND” conditions.

2. The system according to claim 1 wherein the “FIND” conditions to find the data/record(s) from the databank are defined by none or one or more classifications including Date, Record ID, Language, Source of Information, Age Group, Type of Literature, Genre and Sub Genre, Title, Author/Poet, Main Characters, Awards won, Book/Publication, and Publisher, and including classifications by keywords, wildcard characters, file attachments, associations, attachment remarks, association remarks, import remarks, or bookmark remarks including, but not limited to, whether or not the record is marked as “Private” or “Public” or either, “Favorite” as well as assigned a rating, and/or by whether or not a Record has been used in a literature session and if so, the number of times it has been used.

3. The system according to claim 1 wherein said literature bank module allows the user to classify the data/record(s) by classifications selected or added in one or more groups comprising Date, Record ID, Language, Source of Information, Age Group, Type of Literature, Genre and Sub Genre, Author/Poet, and Publisher.

4. The system according to claim 1 wherein said literature bank module allows the user to store additional information about a work of literature including Synopsis, Background of Literature, Critical Appreciation, Book/Publication, Awards Won, Main Characters, and Remarks.

5. The system according to claim 1 wherein said literature bank module allows the user to find data/record(s) from the databank which have similar classifications.

6. The system according to claim 1 wherein said literature bank module comprises a utility for copying of existing classification and previously entered data/record(s) for new data/record input by the user, for ease of data entry, with a choice of defining an extent of details to be copied.

7. The system according to claim 1 wherein the modules include a literature session module which allows the user to invoke and store a literature session for continuous entertainment/enjoyment including improvement of one's knowledge of works of literature including novels, short stories, poems, essays, scripts, rhymes, theses, verse, composition, manuscripts, transcripts, articles, using the data/record(s) from the databank, such data/record(s) having been selected by the user by finding the same from the databank, based on none or one or more “FIND” conditions.

8. The system according to claim 1 wherein the modules include an export module, which allows the user to export data/record(s) from the databank, such data/record(s) having been selected by the user by finding the same by none or one or more FIND conditions.

9. The system according to claim 1 wherein the modules include an import module, which allows the user to import data/record(s) built by another user using the same system.

10. The system according to claim 9 wherein the import module further includes a utility, which allows the user to selectively import the data/record(s).

11. The system according to claim 1 wherein the modules include a global changes module, which allows the user to modify data/record(s), delete data/record(s), bookmark data/record(s), mark data/record(s) as “Public” or “Private” and/or “Favorite”, assign a rating, associate additional information in the form of file(s)/URL(s)/remark(s) to data/record(s), attach a file such as an image, animation, or a sound file to data/record(s), or translate data/record(s), individually as well as globally.

12. The system according to claim 1 wherein the modules include a recycle bin module, which allows the user to restore or permanently remove data/record(s) individually or plurally from the databank.

13. The system according to claim 1 wherein the modules include a reports module, which allows the user to print reports and/or graphs from the data/record(s) in the databank, by finding the same by none or one or more “FIND” conditions.

14. The system according to claim 1 wherein the modules include a translation module, which allows the user to translate data/record(s) in the databank, from one language into another of the user's choice, individually or globally.

15. The system according to claim 1 wherein the modules include a tools/help menu options module, which allows the user to select an option for customization including system maintenance and updating of databases.

16. The system according to claim 1 wherein the modules include a master module, which allows the user to create and store masters for well-defined classifications.

17. The system according to according to claim 1 wherein the modules and utilities are adapted to be operated within a browser and/or other viewing and/or processing programs and to operate on one or more computer systems including hand held devices.

18. An interactive system for building, organizing, and sharing one's own databank of works of literature including novels, short stories, poems, essays, scripts, rhymes, theses, verse, composition, manuscripts, transcripts, articles and such others, in one or more languages, using a computer system, said interactive system comprising:
i) a user interface;
ii) one or more well-classified databases to store data/record(s) user wise including a literature bank database, a translation database, a user database, and a configuration database;
iii) at least one well classified literature bank module to input, organize and manage one's own databank of works of literature in the form of data/record(s) in the databases for classifying the data/records by classifications selected or added in one or more groups comprising Date, Record ID, Language, Source of Information, Age Group, Type of Literature, Genre and Sub Genre, Author/Poet, and Publisher; and
iv) a control system acting as a bridge between the module and the databases to display relevant record(s) on the user interface by finding the same from the databank, based on none or one or more “FIND” conditions.

19. The system according to claim 18 wherein said literature bank module comprises a utility for copying of existing classification and previously entered data/record(s) for new data/record input by the user, for ease of data entry, with a choice of defining an extent of details to be copied.

20. The system according to claim 18 wherein the literature bank module allows the user to modify a record individually and further comprises of a utility, which allows the user to modify data/records globally.
